(19) United States
(12) Patent Application Publication
(10) Pub. No.: US 2014/0006017 A1
(43) Pub. Date: Jan. 2, 2014

(54) SYSTEMS, METHODS, APPARATUS, AND COMPUTER-READABLE MEDIA FOR GENERATING OBFUSCATED SPEECH SIGNAL

(71) Applicant: QUALCOMM INCORPORATED, San Diego, CA (US)

(72) Inventor: Dipanjan Sen, San Diego, CA (US)

(73) Assignee: QUALCOMM Incorporated, San Diego, CA (US)

(21) Appl. No.: 13/780,233

(22) Filed: Feb. 28, 2013

Related U.S. Application Data
(60) Provisional application No. 61/666,196, filed on Jun. 29, 2012.

(51) Int. Cl. G10L 21/003

(52) U.S. Cl. CPC G10L 21/003
USPC 704/208; 704/226; 704/205

(57) ABSTRACT

Arrangements are described that may be used to reduce the intelligibility of speech using masker signals which are obfuscated yet correlated versions of the speech. Other applications of pitch analysis and demodulation are also described. A system may be used to drive an array of loudspeakers to produce a sound field that includes a source component, whose energy is concentrated along a first direction relative to the array, and a masking component that is based on an estimated intensity of the source component in a second direction that is different from the first direction.

### CLAIM OF PRIORITY UNDER 35 U.S.C. §119

The present Application for Patent claims priority to Provisional Application No. 61/666,196, entitled “SYSTEMS, METHODS, APPARATUS, AND COMPUTER-READABLE MEDIA FOR GENERATING CORRELATED MASKING SIGNAL,” filed Jun. 29, 2012, and assigned to the assignee hereof.

### BACKGROUND

1. Field

This disclosure is related to audio signal processing.

2. Background

An existing approach to audio masking applies the fundamental concept that a tone can mask other tones that are at nearby frequencies and are below a certain relative level. With a high enough level, a white noise signal may be used to mask speech, and such a sound masking design may be used to support secure conversations in offices.

Other approaches to restricting the area within which a sound may be heard include ultrasonic loudspeakers, which require different fundamental hardware designs; headphones, which provide no freedom if the user desires ventilation at his or her head, and general sound maskers as may be used in a national security office, which typically involve large-scale fixed construction.

### SUMMARY

A method of signal processing according to a general configuration includes producing a multichannel source signal that is based on a speech signal; producing an obfuscated speech signal that is based on the speech signal; and producing a multichannel masking signal that is based on the obfuscated speech signal. This method also includes driving a directionally controllable transducer, in response to the multichannel source signal and the multichannel masking signal, to produce a sound field comprising (A) a source component that is based on the multichannel source signal and (B) a masking component that is based on the multichannel masking signal. Computer-readable storage media (e.g., non-transitory media) having tangible features that cause a machine reading the features to perform such a method are also disclosed.

An apparatus for signal processing according to a general configuration includes means for producing a multichannel source signal that is based on a speech signal; means for producing an obfuscated speech signal that is based on the speech signal; and means for producing a multichannel masking signal that is based on the obfuscated speech signal. This apparatus also includes means for driving a directionally controllable transducer, in response to the multichannel source signal and the multichannel masking signal, to produce a sound field comprising (A) a source component that is based on the multichannel source signal and (B) a masking component that is based on the multichannel masking signal.

An apparatus for signal processing according to another general configuration includes a first spatially directive filter configured to produce a multichannel source signal that is based on a speech signal; a masking signal generator configured to produce an obfuscated speech signal that is based on the speech signal; and a second spatially directive filter configured to produce a multichannel masking signal that is based on the obfuscated speech signal. This apparatus also includes an audio output stage configured to drive a directionally controllable transducer, in response to the multichannel source signal and the multichannel masking signal, to produce a sound field comprising (A) a source component that is based on the multichannel source signal and (B) a masking component that is based on the multichannel masking signal.

### BRIEF DESCRIPTION OF THE DRAWINGS

FIG. 1A shows a flowchart of a method M100 according to a general configuration.

FIG. 1B shows a flowchart of an implementation M102 of method M100.

FIG. 1C shows a flowchart of an implementation T120 of task T100.

FIG. 1D shows a flowchart of an implementation T130 of task T100.

FIG. 1E shows a flowchart of an implementation T135 of task T100.

FIGS. 2A-F show examples of magnitude responses (in decibels) vs. normalized frequency for biquad bandpass filters for pitch harmonics.

FIG. 3A shows a flowchart of a method M150 according to a general configuration.

FIG. 3B shows a flowchart of an implementation M200 of method M100.

FIG. 3C shows a block diagram of a apparatus MF100 according to a general configuration

FIG. 3D shows a block diagram of an implementation MF102 of apparatus MF100.

FIG. 4A shows a block diagram of an implementation F120 of means MF100.

FIG. 4B shows a block diagram of an implementation F130 of means MF100.

FIG. 4C shows a block diagram of an implementation F135 of means MF100.

FIG. 4D shows a block diagram of an apparatus MF150 according to a general configuration.

FIG. 4E shows a block diagram of an implementation MF200 of apparatus MF100.

FIG. 5A shows a block diagram of a apparatus A100 according to a general configuration

FIG. 5B shows a block diagram of an implementation A102 of apparatus A100.

FIG. 5C shows a block diagram of an implementation A105 of apparatus A100.

FIG. 5D shows a block diagram of an apparatus A150 according to a general configuration.

FIG. 5E shows a block diagram of an implementation A200 of apparatus A100.

FIG. 6 shows an example of a privacy zone generated by a device having a loudspeaker array.

FIG. 7 shows an example of an excessive masking level.

FIG. 8 shows an example of an insufficient masking level.

FIG. 9 shows an example of an appropriate level of the masking field.

FIG. 10A shows a flowchart of a method of producing a sound field M300 according to a general configuration.

FIG. 10B illustrates an application of method M300.

FIG. 11 illustrates an application of an implementation M302 of method M300.

FIG. 12 shows a flowchart of an implementation T510 of task T502.

FIGS. 13A, 13B, 14A, and 14B show examples of a beam pattern of a DSB filter for a four-element array for four different orientation angles.

FIGS. 15A and 15B show examples of beam patterns for weighted modifications of the DSB filters of FIGS. 14A and 14B, respectively.

FIGS. 16A and 16B show examples of a beam pattern of a DSB filter for an eight-element array, in which the orientation angle of the filter is thirty and sixty degrees, respectively.

FIGS. 17A and 17B show examples of beam patterns for weighted modifications of the DSB filters of FIGS. 16A and 16B, respectively.

FIGS. 18A and 18B show examples of schemes having three and five selectable fixed spatial sectors, respectively.

FIG. 18C shows a flowchart of an implementation M310 of method M300.

FIG. 18D shows a flowchart of an implementation M320 of method M300.

FIG. 19 shows a flowchart of an implementation T714 of tasks T702 and T710.

FIG. 20A shows examples of beam patterns of DSB filters for driving a four-element array to produce a source component and a masking component.

FIG. 20B shows examples of beam patterns of DSB filters for driving a four-element array to produce a source component and a masking component.

FIGS. 21A and 21B show results of subtracting the beam patterns of FIG. 20A from each other.

FIGS. 22A and 22B show results of subtracting the beam patterns of FIG. 20B from each other.

FIGS. 23A, 23B, and 24 show examples of beam patterns of DSB filters for driving a four-element array to produce a source component and a masking component.

FIG. 25 shows a use case in which a loudspeaker array provides several programs to different listeners simultaneously.

FIG. 26A shows a top view of a misaligned arrangement of a sensing array of microphones and an emitting array of loudspeakers.

FIG. 26B shows a flowchart of an implementation M330 of method M300.

FIG. 26C shows an example of a multi-sensory reciprocal arrangement of transducers.

FIGS. 27A, 27B, 28A, 28B, and 29 show aspects of pairwise BFNF operations.

FIG. 30 shows a diagram of a typical use scenario for an implementation of method M300.

FIG. 31A shows a block diagram of an apparatus for signal processing MF300 according to a general configuration.

FIG. 31B shows a block diagram of an implementation MF302 of apparatus MF300.

FIG. 31C shows a block diagram of an implementation MF330 of apparatus MF300.

FIG. 32A shows a block diagram of an apparatus for signal processing A300 according to a general configuration.

FIG. 32B shows a block diagram of an implementation A302 of apparatus A300.

FIG. 32C shows a block diagram of an implementation A330 of apparatus A300.

FIG. 33A shows an audio preprocessing stage AP10.

FIG. 33B shows a block diagram of an implementation AP20 of audio preprocessing stage AP10.

FIG. 34A shows an example of a cone-type loudspeaker.

FIG. 34B shows an example of a rectangular loudspeaker.

FIG. 34C shows an example of an array of twelve loudspeakers.

FIG. 34D shows an example of an array of twelve loudspeakers.

FIG. 35A shows a uniform linear array of loudspeakers.

FIG. 35B shows one example of a uniform linear array having symmetrical octave spacing between the loudspeakers.

FIG. 35C shows an example of a uniform linear array having asymmetrical octave spacing.

FIG. 35D shows an example of a curved array having uniform spacing.

FIG. 36A shows a display device TV 10.

FIG. 36B shows a display device TV20.

FIG. 36C shows a front view of a laptop computer D710.

FIGS. 37A and 37B show top views of two examples of an expanded array.

FIGS. 37C and 38 show front views of two different arrays

### DETAILED DESCRIPTION

The systems, methods, and apparatus described herein include arrangements that may be used to reduce the intelligibility of a speech signal using a masking signal that is an obfuscated yet correlated version of the speech signal. In this context, obfuscation of a speech signal indicates reducing intelligibility of the speech signal.

Unless expressly limited by its context, the term “signal” is used herein to indicate any of its ordinary meanings, including a state of a memory location (or set of memory locations) as expressed on a wire, bus, or other transmission medium. Unless expressly limited by its context, the term “generating” is used herein to indicate any of its ordinary meanings, such as computing or otherwise producing. Unless expressly limited by its context, the term “calculating” is used herein to indicate any of its ordinary meanings, such as computing, evaluating, estimating, and/or selecting from a plurality of values. Unless expressly limited by its context, the term “obtaining” is used to indicate any of its ordinary meanings, such as calculating, deriving, receiving (e.g., from an external device), and/or retrieving (e.g., from an array of storage elements). Unless expressly limited by its context, the term “selecting” is used to indicate any of its ordinary meanings, such as identifying, indicating, applying, and/or using at least one, and fewer than all, of a set of two or more. Unless expressly limited by its context, the term “determining” is used to indicate any of its ordinary meanings, such as deciding, establishing, concluding, calculating, selecting, and/or evaluating. Where the term “comprising” is used in the present description and claims, it does not exclude other elements or operations. The term “based on” (as in “A is based on B”) is used to indicate any of its ordinary meanings, including the cases (i) “derived from” (e.g., “B is a precursor of A”), (ii) “based on at least” (e.g., “A is based on at least B”) and, if appropriate in the particular context, (iii) “equal to” (e.g., “A is equal to B” or “A is the same as B”). Similarly, the term “in response to” is used to indicate any of its ordinary meanings, including “in response to at least.” Unless otherwise indicated, the terms “at least one of A, B, and C,” “one or more of A, B, and C,” “at least one among A, B, and C,” and “one or more among A, B, and C” indicate “A and/or B and/or C.” Unless otherwise indicated, the terms “each of A, B, and C” and “each among A, B, and C” indicate “A and B and C.”

References to a “location” of a microphone of a multi-microphone audio sensing device indicate the location of the center of an acoustically sensitive face of the microphone, unless otherwise indicated by the context. The term “channel” is used at times to indicate a signal path and at other times to indicate a signal carried by such a path, according to the particular context. Unless otherwise indicated, the term “series” is used to indicate a sequence of two or more items. The term “logarithm” is used to indicate the base-ten logarithm, although extensions of such an operation to other bases are within the scope of this disclosure. The term “frequency component” is used to indicate one among a set of frequencies or frequency bands of a signal, such as a sample (or “bin”) of a frequency domain representation of the signal (e.g., as produced by a fast Fourier transform) or a subband of the signal (e.g., a Bark scale or mel scale subband).

Unless indicated otherwise, any disclosure of an operation of an apparatus having a particular feature is also expressly intended to disclose a method having an analogous feature (and vice versa), and any disclosure of an operation of an apparatus according to a particular configuration is also expressly intended to disclose a method according to an analogous configuration (and vice versa). The term “configuration” may be used in reference to a method, apparatus, and/or system as indicated by its particular context. The terms “method,” “process,” “procedure,” and “technique” are used generically and interchangeably unless otherwise indicated by the particular context. A “task” having multiple subtasks is also a method. The terms “apparatus” and “device” are also used generically and interchangeably unless otherwise indicated by the particular context. The terms “element” and “module” are typically used to indicate a portion of a greater configuration. Unless expressly limited by its context, the term “system” is used herein to indicate any of its ordinary meanings, including “a group of elements that interact to serve a common purpose.”

Any incorporation by reference of a portion of a document shall also be understood to incorporate definitions of terms or variables that are referenced within the portion, where such definitions appear elsewhere in the document, as well as any figures referenced in the incorporated portion. Unless initially introduced by a definite article, an ordinal term (e.g., “first,” “second,” “third,” etc.) used to modify a claim element does not by itself indicate any priority or order of the claim element with respect to another, but rather merely distinguishes the claim element from another claim element having a same name (but for use of the ordinal term). Unless expressly limited by its context, each of the terms “plurality” and “set” is used herein to indicate an integer quantity that is greater than one.

It may be assumed that in the near-field and far-field regions of an emitted sound field, the wavefronts are spherical and planar, respectively. The near-field may be defined as that region of space which is less than one wavelength away from a sound receiver (e.g., a microphone array). Under this definition, the distance to the boundary of the region varies inversely with frequency. At frequencies of two hundred, seven hundred, and two thousand hertz, for example, the distance to a one-wavelength boundary is about 170, forty-nine, and seventeen centimeters, respectively. It may be useful instead to consider the near-field/far-field boundary to be at a particular distance from the microphone array (e.g., fifty centimeters from a microphone of the array or from the centroid of the array, or one meter or 1.5 meters from a microphone of the array or from the centroid of the array).

Examples of audio sensing devices that may be implemented to include a multi-microphone array and to perform a method as described herein include portable computing devices (e.g., laptop computers, notebook computers, netbook computers, ultra-portable computers, tablet computers, mobile Internet devices, smartbooks, smartphones, etc.), audio- or video-conferencing devices, and display screens (e.g., computer monitors, television sets).

It may be desirable to obfuscate a speech signal (i.e., to reduce intelligibility). For a case in which the speech signal is part of a confidential conversation, it may be desirable to direct an obfuscated version of the speech signal into a surrounding space to prevent a bystander or intentional eavesdropper from understanding the words being spoken. For a case in which the speech signal is part of a scene being recorded (e.g., a surveillance video), it may be desirable to obfuscate the speech signal to provide an accurate representation of the acoustic environment while maintaining the privacy of the spoken communication.

Examples of methods of reducing speech intelligibility include replacing linear prediction coding (LPC) coefficients of the speech signal as described in U.S. Pat. No. 8,140,326 B2 (Chen et al) Like a noise-based masking signal, however, such a signal is likely to create a perception of two different sources to a bystander. Another approach to making voice sounds unintelligible to persons nearby includes non-acoustically sensing and processing a user's speech as described in US Publ. Pat. Appl. No. 2012/0053931 A1 (Holzrichter).

A further approach to reducing intelligibility of a speech signal is to change the order of the frames of the speech signal in time as described in US Publ. Pat. Appl. No. 2010/0208912 A1 (Tohyama et al.). While such rearrangement may reduce intelligibility of the speech content, it is likely to alter non-semantic aspects of the speech signal as well (e.g., prosodic information, which carries emotional content). The speech signal may also contain other sounds (e.g., non-speech sounds) as part of the recorded environment, and such rearrangement may also degrade these other sounds.

Methods, systems, and apparatus as described herein may be configured to process the speech signal as a series of segments. Typical segment lengths range from about five or ten milliseconds to about forty or fifty milliseconds, and the segments may be overlapping (e.g., with adjacent segments overlapping by 25% or 50%) or nonoverlapping. In one particular example, the speech signal is divided into a series of nonoverlapping segments or “frames”, each having a length of ten milliseconds. In another particular example, each frame has a length of twenty milliseconds. Examples of sampling rates for the speech signal include (without limitation) eight, twelve, sixteen, 32, 44.1, 48, and 192 kilohertz.

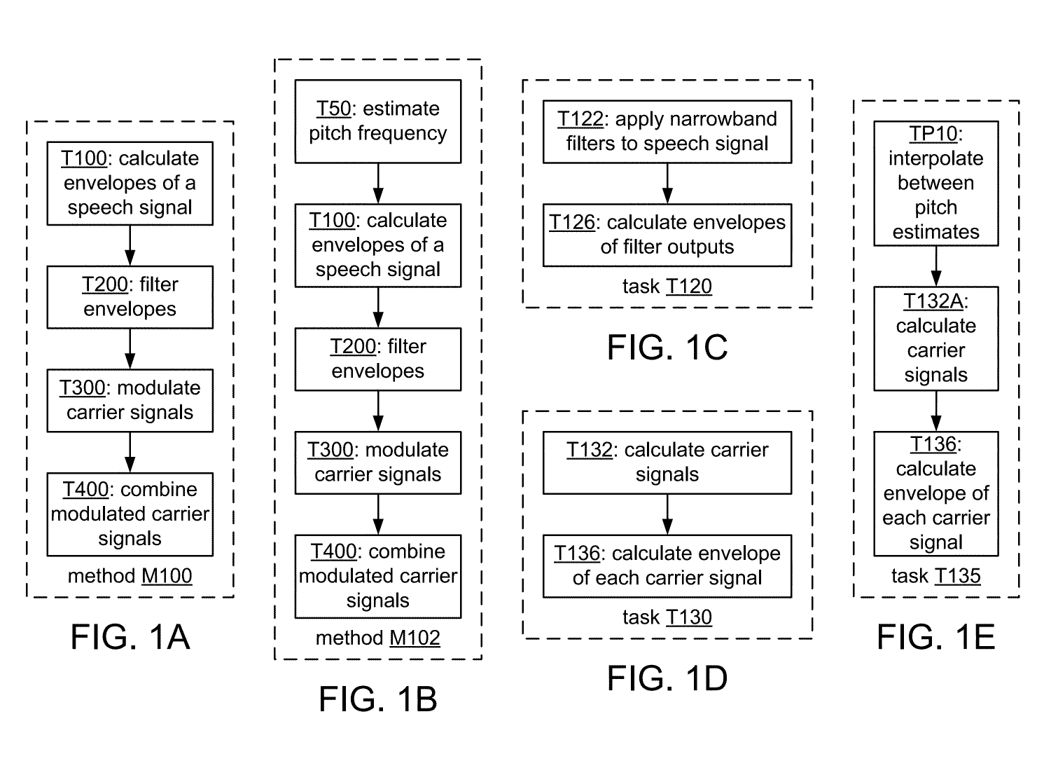

FIG. 1A shows a flowchart of a method M100 of signal processing according to a general configuration that includes tasks T100, T200, T300, and T400. At each of a plurality of different frequencies of a speech signal, task T100 calculates an envelope of the speech signal. Task T200 filters the calculated envelopes, and task T300 uses the filtered envelopes to modulate corresponding ones of a plurality of carrier signals. Task T400 combines the modulated carrier signals to produce an obfuscated speech signal. In practice, method M100 may be implemented such that an instance of method M100 is performed on each of a sequence of frames of the speech signal to produce a corresponding sequence of frames of the obfuscated speech signal.

Voiced segments of a speech signal are typically characterized by a pitch component, which is generated by movement of the vocal cords. It may be desirable to implement method M100 to preserve prosodic information (i.e., change in pitch frequency of the speech signal over time). For example, it may be desirable to implement task T100 such that the plurality of different frequencies of the speech signal are related to a pitch fundamental frequency f₀ of the speech signal. In such case, task T100 may be implemented to calculate the envelopes at frequencies that are harmonics of frequency f₀ (i.e., frequencies fₖ=k×f₀ for integer values of k from 1 to K). Examples of values for the number K of harmonics include four, five, six, seven, eight, nine, and ten, although K may have any other positive non-zero integer value.

Typical values of frequency f₀ range from about 70 to 100 Hz for a male speaker to about 150 to 200 Hz for a female speaker. FIG. 1B shows a flowchart of an implementation M102 of method M100 that includes a pitch frequency estimation task T50. Task T50 may be implemented to estimate the pitch fundamental f₀ from the speech signal using any pitch analysis technique, such as an autocorrelation-based pitch estimation function. For example, task T50 may be implemented to estimate a value of f₀ (e.g., for a frame of the speech signal) by calculating the pitch period as the distance between adjacent pitch peaks. A sample of an input channel may be identified as a pitch peak based on a measure of its energy (e.g., based on a ratio between sample energy and frame average energy) and/or a measure of how well a neighborhood of the sample is correlated with a similar neighborhood of a known pitch peak. Task T50 may also be implemented to divide the speech signal into a sequence of frames as described herein (e.g., having a length of ten or twenty milliseconds).

Task T50 may be implemented to estimate a pitch frequency for each voiced frame of the speech signal, where the pitch frequency may vary from one frame to another. For example, task T50 may be implemented to perform a pitch estimation procedure as described in section 4.6.3 (pp. 4-44 to 4-49) of EVRC (Enhanced Variable Rate Codec) document C.S0014-C, available online at www-dot-3gpp-dot-org. Alternatively, for a case in which the speech signal has been decoded from an encoded speech signal obtained from a transmission channel (e.g., a far-end communications signal, as in a telephone call) or from storage, a current estimate of the pitch frequency (e.g., in the form of an estimate of the pitch period or “pitch lag”) will typically already be available. In voice communications using codecs that include pitch estimation, such as code-excited linear prediction (CELP) and prototype waveform interpolation (PWI)), an encoded frame may include a current estimate of the pitch frequency in the form of an estimate of the pitch period or “pitch lag.”

FIG. 1C shows a flowchart of an implementation T120 of task T100 that includes subtasks T122 and T126. Task T122 applies a plurality of narrowband filters (e.g., a bank of narrowband filters in parallel) to the speech signal to obtain a corresponding plurality of narrowband signals. A narrowband filter may be defined as a bandpass filter having a bandwidth (e.g., at −3 decibels) that is not greater than 1/12, ⅙, ¼, ⅓, or ½ octave (i.e., 1, 2, 3, 4, or 6 semitones) with respect to its center frequency.

Task T122 may be implemented such that each of the plurality N of narrowband filters is centered at a corresponding one of N pitch harmonics (e.g., for N=K). In such case, task T122 may be implemented to reconfigure the narrowband filters (e.g., periodically and/or upon some event) according to a current pitch estimate. For example, such reconfiguration may be performed at each frame, at some other interval (e.g., every two, three, five, or ten frames), or in response to some event (e.g., detection of a change in frequency f₀). It may be desirable to implement task T122 to perform such reconfiguration only when the corresponding frame of the speech signal is voiced.

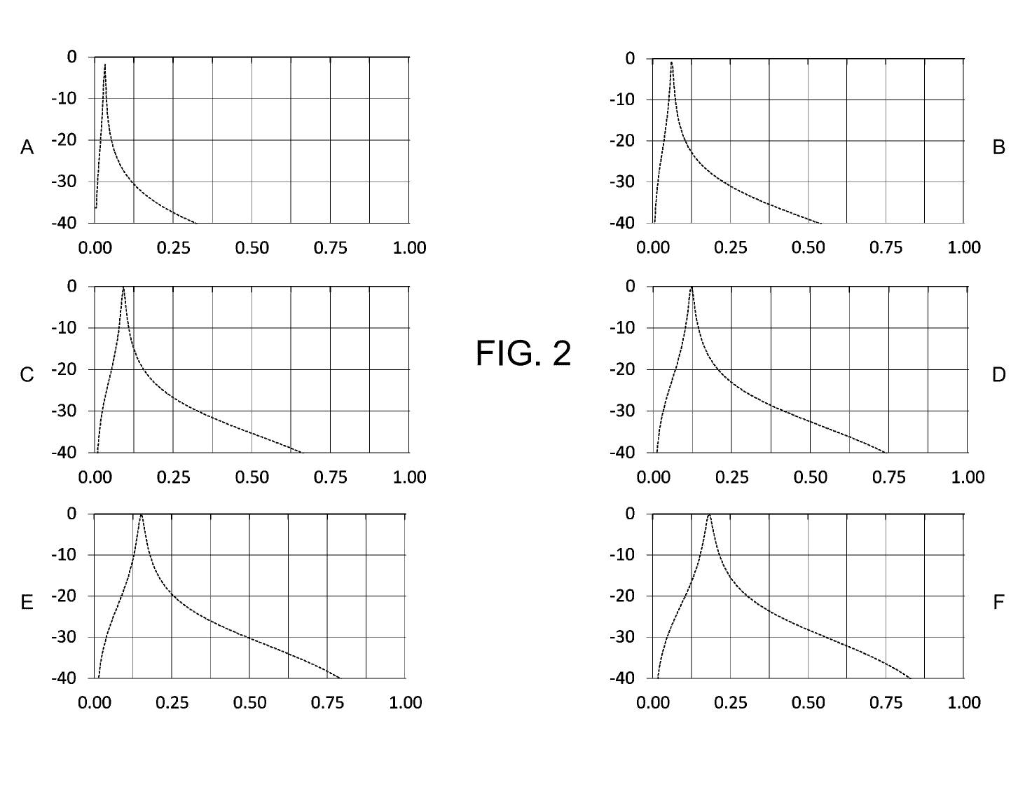

It may be desirable to implement each of the plurality of narrowband filters as a biquad filter (i.e., a second-order infinite-impulse-response filter) or according to another reconfigurable design. For example, task T122 may be implemented to calculate the coefficients of a biquad bandpass implementation of the narrowband filters from desired values of center frequency (e.g., corresponding pitch harmonic frequency), bandwidth, and sampling rate according to any of several known algorithms. FIGS. 2A-F show examples of magnitude responses (in decibels) vs. normalized frequency for biquad bandpass filters for the first six pitch harmonics, respectively, for a case in which f₀ is 120 Hz, the sampling rate is 8 kHz, and the minus-3-decibel bandwidth is two semitones.

Task T126 calculates envelopes of the outputs of the plurality of narrowband filters. In one example, task T126 is implemented to calculate an amplitude envelope of the output of each filter (e.g., as a magnitude of each sample of the filter output). In another example, task T126 is implemented to calculate an energy envelope of the output of each filter (e.g., as a squared magnitude of each sample of the filter output). In a further example, task T126 is implemented to calculate a complex envelope of the output of each filter (e.g., at the corresponding pitch harmonic).

In a related approach, the speech signal is modeled as a superposition of modulated carrier signals. The envelopes of these modulated carrier signals may be expected to carry intelligible cues. In one such example, the carrier signals are harmonics of the pitch fundamental f₀.

FIG. 1D shows a flowchart of an implementation T130 of task T100 that includes subtasks T132 and T136. Task T132 calculates a plurality of carrier signals, and task T136 calculates an envelope of the speech signal at the frequency of each carrier signal. As noted above, it may be desirable to implement task T130 to calculate the envelopes at frequencies that are related to a pitch fundamental frequency f₀ of the speech signal. In such case, task T132 may be implemented to generate the carrier signals at harmonics of frequency f₀. For example, task T132 may be implemented to calculate each carrier signal Cₖ, 1<=k<=K, as a complex (i.e., quadrature) sinusoid at the corresponding frequency according to an expression such as

$${C}_{k} [ n ] = exp ( \frac{j 2 π {\int }^{n} {kf}_{0}}{{f}_{s}} ) ,$$

where n is a sample index, f₀ is the pitch fundamental frequency, and fₛ is the sampling frequency.

As described above, method M100 may be implemented to calculate or receive an estimate of frequency f₀ for each voiced frame of the speech signal. It may be desirable to avoid an abrupt shift in frequency of the carrier signals from one pitch estimate to the next, as such a shift may introduce artifacts into the calculated envelopes. FIG. 1E shows a flowchart of an implementation T135 of task T130 that includes a task TP10, which interpolates between the calculated or received pitch estimates (e.g., using linear interpolation, polynomial interpolation, or spline interpolation) to provide a pitch track that has a higher resolution in the time dimension. For example, task TP10 may be implemented to calculate a pitch track (also called a “pitch trajectory”) that includes a corresponding interpolated pitch frequency for each sample of the speech signal. Additionally or alternatively, task TP10 may be implemented to interpolate between pitch estimates to provide values for frames for which pitch information is not available (e.g., unvoiced segments).

Task T135 also includes an implementation T132A of task T132 that calculates the carrier signals as harmonics of the frequency indicated by the pitch track. In one example, task T132A is implemented to calculate each carrier signal Cₖ, 1<=k<=K, as a complex (i.e., quadrature) sinusoid at the corresponding frequency according to an expression such as

$${C}_{k} [ n ] = exp ( \frac{j 2 π {\int }^{n} {kf}_{0} [ n ]}{{f}_{s}} ) ,$$

where f₀[n] is the pitch fundamental at sample n.

Task T136 calculates an envelope of the speech signal at the frequency of each carrier signal. For example, task T136 may be implemented to generate each envelope by demodulating the speech signal at the frequency of the corresponding carrier signal. In one example, task T136 is implemented to calculate each envelope Eₖ, 1<=k<=K, as a complex envelope according to an expression such as

Eₖ[n]=s[n]×Cₖ*[n],

where s[n] denotes the speech signal and the asterisk denotes the complex conjugate.

Task T200 filters the plurality of calculated envelopes to produce a corresponding plurality of filtered envelopes. It may be desirable to implement task T200 to remove information from the envelopes that is important to intelligibility. For example, task T200 may be implemented to attenuate high-frequency components of the envelope, which may contribute to semantic content of the speech signal, while retaining low-frequency components of the envelope, which may carry prosodic information. In one example, task T200 is implemented to apply a low-pass filter having a cutoff frequency f_{c} of five Hz to each envelope to produce the corresponding filtered envelope. Examples of values for f_{c} that may be used in other such implementations of task T200 include, without limitation, three, four, six, and seven Hz. In another example, task T200 is implemented to apply low-pass filters having different cutoff frequencies to different envelopes (e.g., a lower cutoff frequency for the envelope that corresponds to the fundamental than for the envelope that corresponds to the highest harmonic).

Task T300 modulates a plurality of carrier signals with corresponding ones of the filtered envelopes to produce a plurality of modulated carrier signals. The carrier signals may be narrowband signals at harmonics of the current pitch fundamental f₀, or the complex sinusoids Cₖ[n] as described above, which may have pitch-track-based frequencies. For example, task T300 may be implemented to produce the modulated carrier signals Mₖ, 1<=k<=K, according to an expression such as

Mₖ[n]=Eₖ_{_{LP}}[n]Cₖ[n],

where Eₖ_{_{LP}} denotes the corresponding envelopes (e.g., lowpass-filtered envelopes) produced by task T200.

If the harmonics modulated in task T300 are exact integer multiples of the pitch fundamental f₀, the resulting obfuscated speech signal may sound a bit mechanical. It may be desirable to implement task T300 to modulate a plurality of carrier signals at harmonics of frequency f₀ that are obtained by adding noise to the complex sinusoids Cₖ[n] as described above. In one example, task T300 is configured to calculate the carrier signals Cₖ′[n] according to an expression such as

Cₖ′[n]=Cₖ[n]+zₖ[n],

where zₖ[n] denotes a noise signal (e.g., white or pink noise) that shifts the frequency of the carrier signal slightly to provide a jitter to the synthesized pitch. In such case, task T300 may be implemented to produce the modulated carrier signals according to an expression such as

Mₖ[n]=Eₖ_{_{LP}}[n]Cₖ′[n].

Task T400 combines the modulated carrier signal to produce the obfuscated speech signal. In one example, task T400 is implemented to produce the obfuscated speech signal according to an expression such as

$$m [ n ] = Re \{ {\sum }_{k} {M}_{k} [ n ] \} ,$$

where m[n] denotes the obfuscated speech signal.

While voice-based methods as described in U.S. Pat. No. 8,140,326 B2 and US Publ. Pat. Appl. No. 2012/0053931 A1 are active only during voiced segments (e.g., vowels), a modulation-based scheme as described herein may be used during voiced segments only, during both voiced and unvoiced segments, or during all segments. It is also noted that a modulation-based obfuscated speech signal as produced by an implementation of method M100 may be used in addition to other maskers, such as white or pink noise, waterfall noise, etc. For applications in which it is desired to mask speech from more than one speaker, method M100 may be implemented to perform a multi-pitch analysis to calculate a corresponding pitch track for each speaker.

Use cases for an obfuscated yet correlated speech signal include masking intelligibility of speech within a source signal. For example, it may be desirable to preserve an accurate record of an acoustic environment (e.g., an environment that is being monitored or recorded) without compromising the privacy of individuals speaking within that environment. In such case, an obfuscated speech signal as produced by an implementation of method M100 may be combined with the recorded signal in order to obscure the intelligibility of the speech.

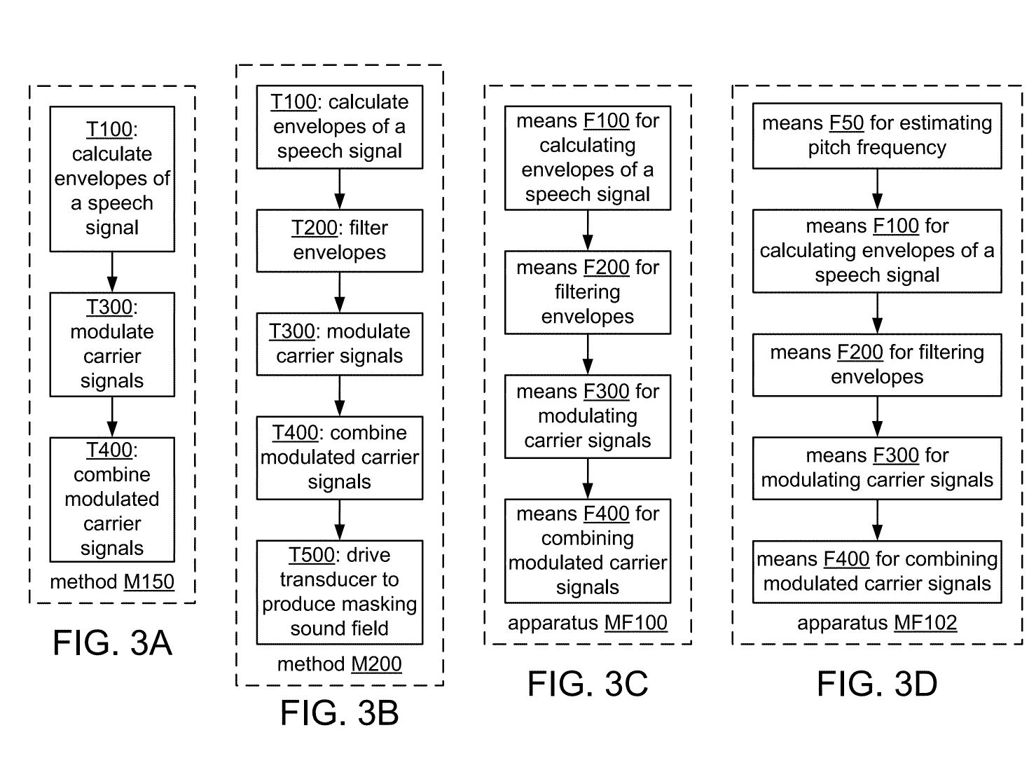

Other applications of using pitch analysis and demodulation to separate an information-carrying component of the speech signal from a speaker-characterizing component include voice morphing. FIG. 3A shows a flowchart of a method M150 of signal processing according to a general configuration that includes instances of tasks T100, T300, and T400. In this case, task T300 is implemented to use the envelopes produced by task T100 to modulate carrier signals that are based on a different pitch track (e.g., carrier signals at harmonic frequencies that are based on a different fundamental frequency). Such a method may be used to obscure the identity of the speaker, or to generate a different persona, while preserving intelligibility of the speech. Alternatively or additionally, task T300 may be implemented to alter the frequency of the pitch track over time in order to change the tone of the speaker's expression. Further use cases for such pitch analysis and demodulation include scrambling (e.g., encryption) of a speech signal, and voice identification (i.e., speaker recognition).

An obfuscated speech signal as produced by an implementation of method M100 may be used to provide a privacy zone. For example, it may be desirable to confine the intelligible content of a person's voice to a particular space, such as the cubicle, office, or conference room in which the person is speaking, and to prevent persons outside that space (e.g., in an adjoining room or cubicle) from understanding that speech. In such cases, method M100 may be implemented to receive the speech signal via one or more microphones, and the resulting obfuscated speech signal may be used to drive a transducer (e.g., a loudspeaker) to create a masking sound field directed away from the privacy zone. In one example, a handset is implemented to perform method M100 and to drive a rear speaker of the handset to create a masking sound field directed away from the user's ear.

FIG. 3B shows a flowchart of an implementation M200 of method M100 that includes a task T500, which drives a transducer to produce the masking sound field. When a directionally controllable transducer (e.g., an array of loudspeakers) is available, task T500 may be implemented to produce the masking sound field according to a desired spatial pattern as described herein. A directionally controllable transducer is defined as an element or array of elements (e.g., an array of loudspeakers) that is configured to produce a sound field whose intensity with respect to direction is controllable.

FIG. 3C shows a block diagram of an apparatus for signal processing MF100 according to a general configuration that includes means F100 for calculating, for each of a plurality of frames of the speech signal and for each of a plurality of different frequencies, an envelope of the frame at the frequency (e.g., as described herein with reference to task T100). Apparatus MF100 also includes means F200 for filtering, for each of the plurality of frames of the speech signal, each of the calculated envelopes to obtain a corresponding filtered envelope of a plurality of filtered envelopes (e.g., as described herein with reference to task T200). Apparatus MF100 also includes means F300 for applying, for each of the plurality of frames of the speech signal, each of the plurality of filtered envelopes to a carrier signal at the corresponding frequency to obtain a corresponding modulated carrier signal of a plurality of modulated carrier signals (e.g., as described herein with reference to task T300). Apparatus MF100 also includes means F400 for producing, for each of said plurality of frames of the speech signal, a corresponding frame of the obfuscated speech signal by combining the corresponding plurality of modulated carrier signals (e.g., as described herein with reference to task T400). FIG. 3D shows a block diagram of an implementation MF102 of apparatus MF100 that includes means F50 for estimating, for each of the plurality of frames of the speech signal, a corresponding pitch frequency (e.g., as described herein with reference to task T50).

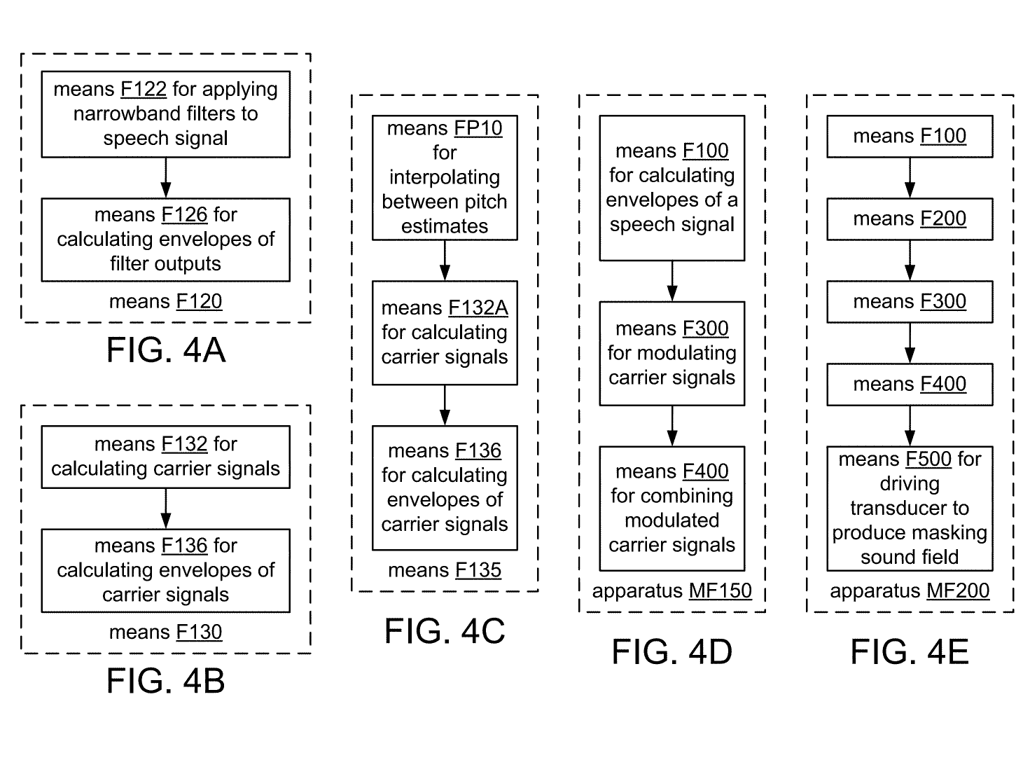

FIG. 4A shows a block diagram of an implementation F120 of means F100 that includes means F122 for applying, to each of the plurality of frames of the speech signal and for each of the plurality of different frequencies, a narrowband filter at the frequency (e.g., as described herein with reference to task T122). Means F120 also includes means F126 for calculating, for each of the plurality of frames of the speech signal and for each of the plurality of different frequencies, an envelope of the output of the corresponding narrowband filter (e.g., as described herein with reference to task T126).

FIG. 4B shows a block diagram of an implementation F130 of means F100 that includes means F132 for calculating, for each of the plurality of frames of the speech signal and for each of the plurality of different frequencies, a carrier signal at the frequency (e.g., as described herein with reference to task T132). Means F130 also includes means F136 for calculating, for each of the plurality of frames of the speech signal and for each of the plurality of different frequencies, an envelope of the corresponding carrier signal (e.g., as described herein with reference to task T136).

FIG. 4C shows a block diagram of an implementation F135 of means F130 that includes means FP10 for interpolating between estimates of a pitch frequency of the speech signal to obtain a pitch track of the speech signal (e.g., as described herein with reference to task TP10) and an implementation F132A of means F132 for calculating the carrier signals based on the pitch track (e.g., as described herein with reference to task T132A).

FIG. 4D shows a block diagram of an apparatus MF150 according to a general configuration that includes instances of means F100, F300, and F400 (e.g., as described herein with reference to method M150). FIG. 4E shows a block diagram of an implementation MF200 of apparatus MF100 that includes means F500 (e.g., amplifying means) for driving a directionally controllable transducer according to an obfuscated speech signal produced by means F400 to produce a masking sound field (e.g., as described herein with reference to task T500).

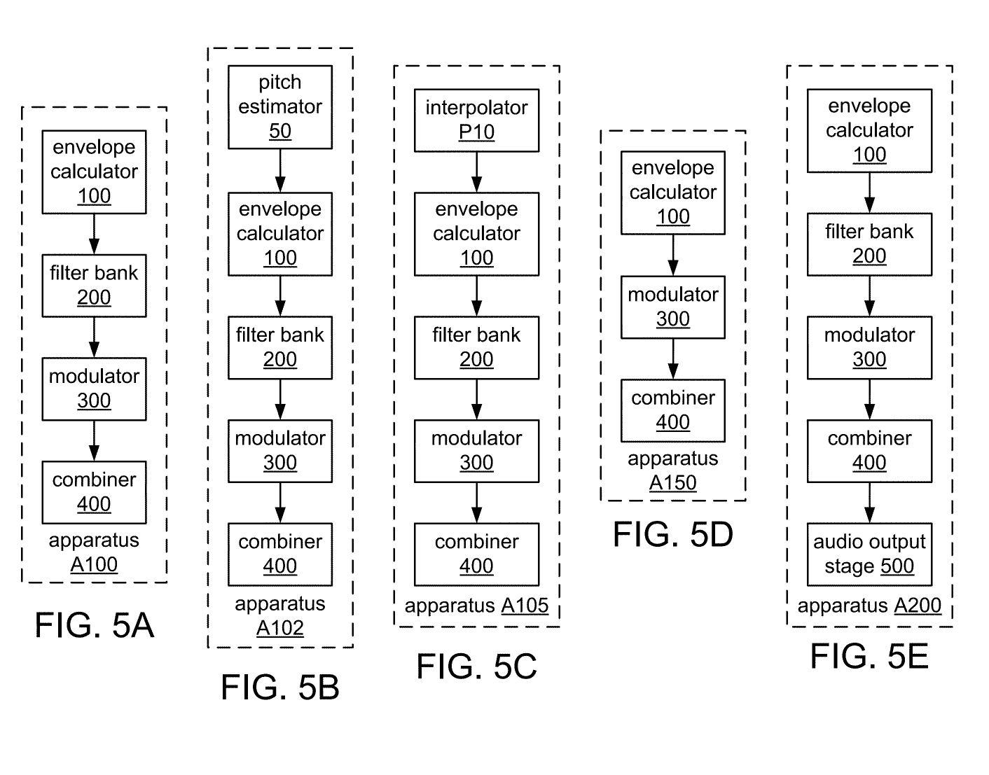

FIG. 5A shows a block diagram of an apparatus for signal processing A100 according to a general configuration that includes an envelope calculator 100, a filter bank 200, a modulator 300, and a combiner 400. Envelope calculator 100 is configured to calculate, for each of a plurality of frames of the speech signal and for each of a plurality of different frequencies, an envelope of the frame at the frequency (e.g., as described herein with reference to task T100). Filter bank 200 is configured to filter, for each of the plurality of frames of the speech signal, each of the calculated envelopes to obtain a corresponding filtered envelope of a plurality of filtered envelopes (e.g., as described herein with reference to task T200). Modulator 300 is configured to apply, for each of the plurality of frames of the speech signal, each of the plurality of filtered envelopes to a carrier signal at the corresponding frequency to obtain a corresponding modulated carrier signal of a plurality of modulated carrier signals (e.g., as described herein with reference to task T300). Combiner 400 is configured to produce, for each of said plurality of frames of the speech signal, a corresponding frame of the obfuscated speech signal by combining the corresponding plurality of modulated carrier signals (e.g., as described herein with reference to task T400). FIG. 5B shows a block diagram of an implementation A102 of apparatus A100 that includes a pitch estimator 50 configured to estimate, for each of the plurality of frames of the speech signal, a corresponding pitch frequency (e.g., as described herein with reference to task T50).

Envelope calculator 120 may be configured to apply, to each of the plurality of frames of the speech signal and for each of the plurality of different frequencies, a narrowband filter at the frequency (e.g., as described herein with reference to task T122) and to calculate, for each of the plurality of frames of the speech signal and for each of the plurality of different frequencies, an envelope of the output of the corresponding narrowband filter (e.g., as described herein with reference to task T126).

Alternatively, envelope calculator 120 may be configured to calculate, for each of the plurality of frames of the speech signal and for each of the plurality of different frequencies, a carrier signal at the frequency (e.g., as described herein with reference to task T132) and to calculate, for each of the plurality of frames of the speech signal and for each of the plurality of different frequencies, an envelope of the corresponding carrier signal (e.g., as described herein with reference to task T136). FIG. 5C shows a block diagram of a corresponding implementation A105 of apparatus A100 that includes an interpolator P10 configured to interpolate between estimates of a pitch frequency of the speech signal to obtain a pitch track of the speech signal (e.g., as described herein with reference to task TP10). In this case, envelope calculator 100 may be configured to calculate the carrier signals based on the pitch track (e.g., as described herein with reference to task T132A).

FIG. 5D shows a block diagram of an apparatus A150 according to a general configuration that includes instances of envelope calculator 100, modulator 300, and combiner 400 (e.g., as described herein with reference to method M150). FIG. 5E shows a block diagram of an implementation A200 of apparatus A100 that includes an audio output stage 500 configured to drive a directionally controllable transducer according to an obfuscated speech signal produced by combiner 400 to produce a masking sound field (e.g., as described herein with reference to task T500).

In another example, it may be desirable to confine the intelligible content of a reproduced speech signal (e.g., a far-end voice communications signal, such as the received channel of a telephone call, or a recorded voice signal) to a particular space. In this case, a directionally controllable transducer (e.g., an array of loudspeakers) may be used to steer beams with different characteristics in various directions of emission and/or to create a private listening zone. By combining different audio contents that are beamed in different directions, we can direct a main beam to carry the communication channel towards the user and masking beams to obscure the communication channel in other directions without interfering with the main beam.

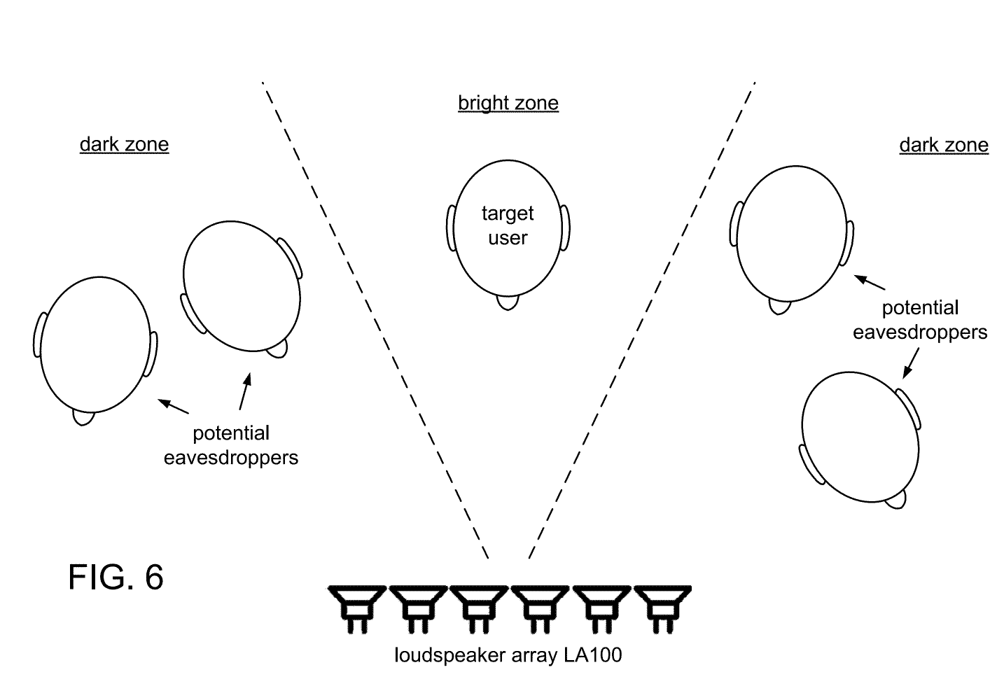

FIG. 6 shows an example of multichannel signal masking in which a device having a loudspeaker array (i.e., an array of two or more loudspeakers) generates a sound field that includes a privacy zone. This example shows the privacy zone as a “bright zone” around the target user where the main communication channel sound (the “source component” of the sound field) is readily audible, while other people (e.g., potential eavesdroppers) are in the “dark zone” where the communication channel sound is weak and is accompanied by a masking component of the sound field. Examples of such a device include a television set, computer monitor, or other video display device coupled with or even incorporating a loudspeaker array; a computer system configured for multimedia playback; and a portable computer (e.g., a laptop or tablet).

A problem may arise when the loudspeaker array is used in a public area, where people in the dark zone may be normal bystanders rather than eavesdroppers, or in a workplace, where the dark zone may encompass people at work. While such a method may be used to preserve the user's privacy, the masking signals are usually unwanted sound pollution with respect to bystanders in the surrounding environment. It may be desirable to provide a system that can achieve good privacy protection for the user and minimal sound pollution to others at the same time.

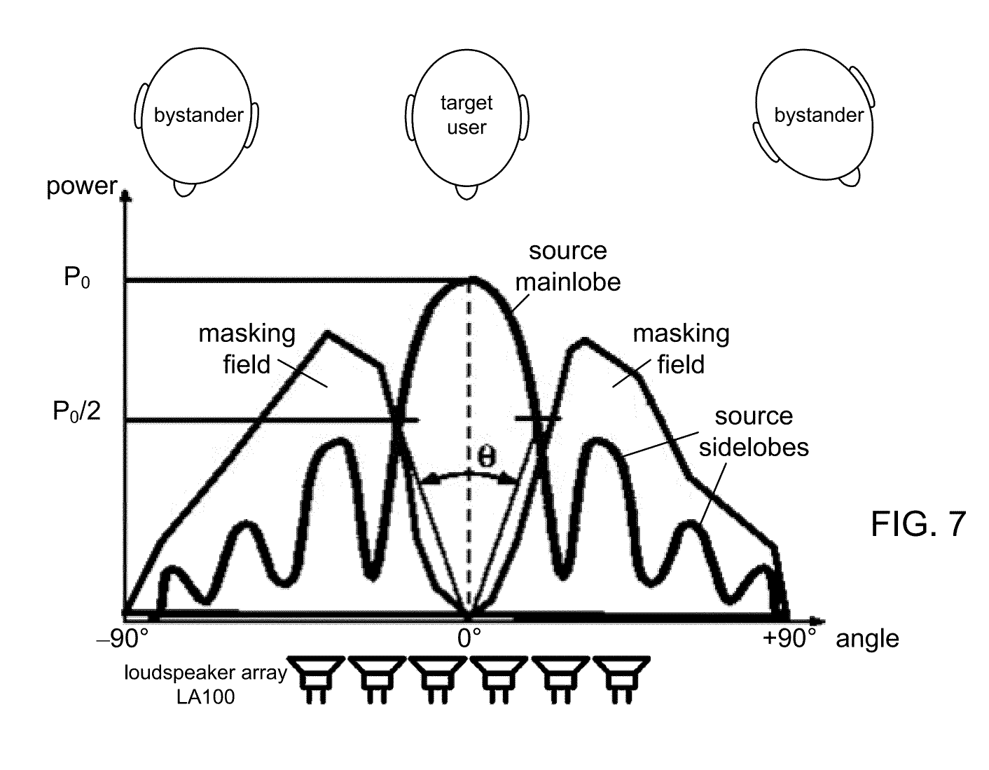

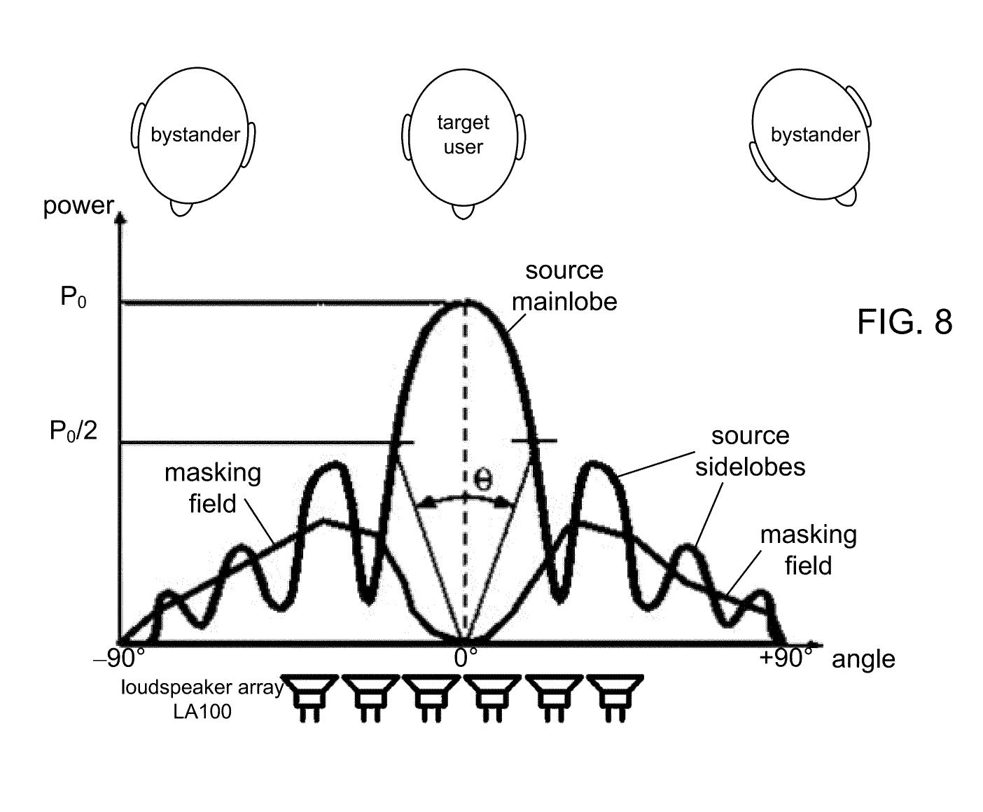

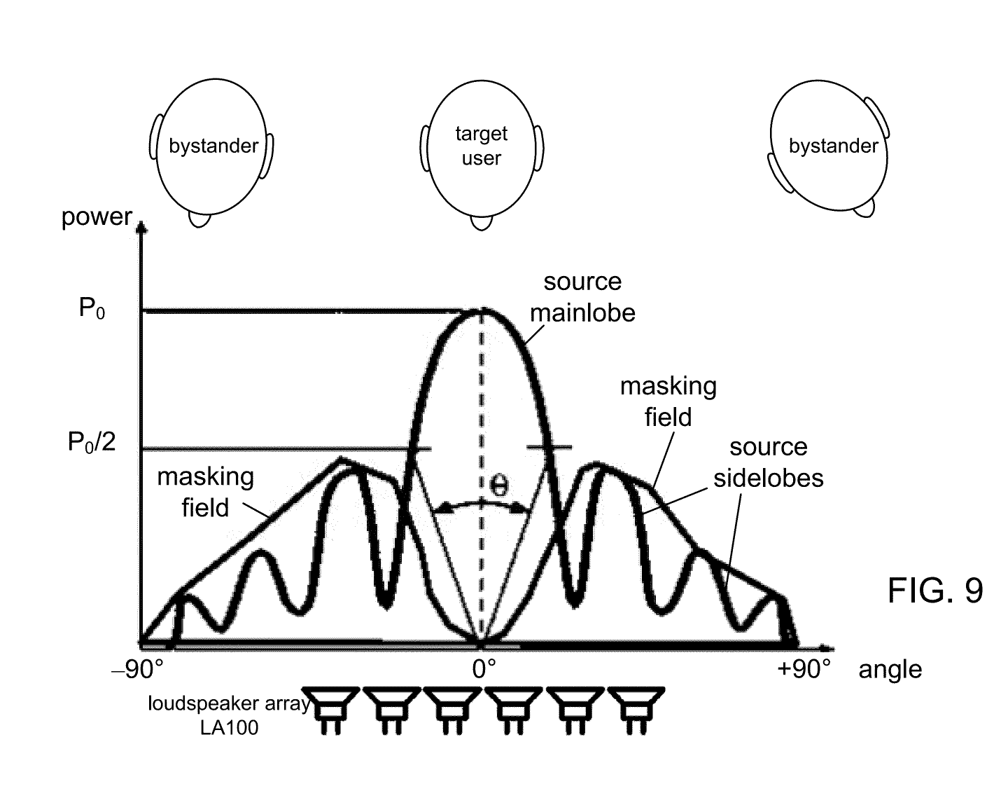

FIG. 7 shows an example of an excessive masking level, in which the power level of the masking component is greater than the power level of the sidelobes of the source component. Such an imbalance may cause unnecessary sound pollution to nearby people. FIG. 8 shows an example of an insufficient masking power level, in which the power level of the masking component is lower than the power level of the sidelobes of the source component. Such an imbalance may cause the main signal to be intelligible to nearby persons. FIG. 9 shows an example of an appropriate power level of the masking component, in which the power level of the masking signal is matched to the power level of the sidelobes of the source component. Such level matching effectively masks the sidelobes of the source component without causing excessive sound pollution.

The effectiveness of an audio masking signal may be dependent on factors such as signal intensity, frequency, and/or content as well as psychoacoustic factors. A critical masking condition is typically a function of several (and possibly all) of these factors. For simplicity in explanation, FIGS. 7-9 use matched power between source and masker to indicate critical masking, less masker power than source power to indicate insufficient masking, and more masker power than source power to indicate excessive masking. In practice, it may be desirable to consider additional factors with respect to the source and masker signals as well, rather than just power.

Generating a masking signal by rearranging frames of the speech signal in time, or by substituting components of the speech signal (e.g., LPC coefficients) with components from other signals, is likely to produce a signal that is uncorrelated with the speech signal. A low degree of correlation increases the likelihood that a bystander hearing both signals will perceive two different sources. A potential advantage of an obfuscated speech signal as produced by an implementation of method M100 is a high degree of correlation with the original speech signal. Such correlation increases the likelihood that a bystander will perceive only one source, providing a masking operation that may be more effective (e.g., at the same power level) and less distracting than other approaches. The bystander may not even notice that a masking activity is being performed.

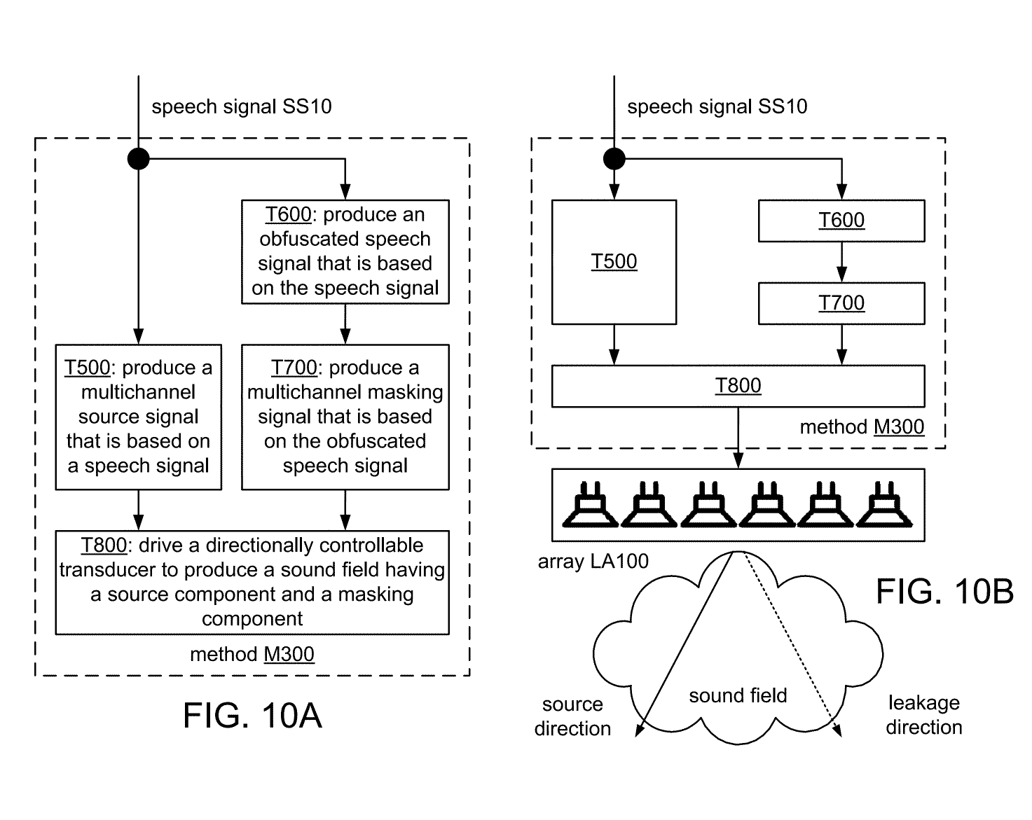

FIG. 10A shows a flowchart of a method of signal processing M300 according to a general configuration that includes tasks T500, T600, T700, and T800. Task T500 produces a first multichannel signal (a “multichannel source signal”) that is based on a speech signal. Task T600 produces an obfuscated speech signal that is based on the speech signal. Task T600 may be implemented to generate the obfuscated speech signal by rearranging frames of the speech signal in time, or by substituting components of the speech signal (e.g., LPC coefficients) with components from other signals. Alternatively, task T600 may be implemented as an instance of method M100 as described herein. In either case, task T600 may also be implemented to mix such a generated signal with noise (e.g., white noise, pink noise, babble noise, ambient noise) to produce the obfuscated speech signal.

Task T700 produces a second multichannel signal (a “multichannel masking signal”) that is based on the obfuscated speech signal. Task T800 drives a directionally controllable transducer to produce a sound field to include a source component that is based on the multichannel source signal and a masking component that is based on the multichannel masking signal. The source component may have an intensity (e.g., magnitude or energy) which is higher in a source direction relative to the array than in a leakage direction relative to the array that is different than the source direction, and task T700 may be implemented to produce the masking signal based on an estimated intensity of the source component in the leakage direction.

FIG. 10B illustrates an application of method M300 to produce the sound field by driving a loudspeaker array LA100. It is typical for each channel of the multichannel source signal to be associated with a corresponding particular loudspeaker of the array. Likewise, it is typical for each channel of the multichannel masking signal to be associated with a corresponding particular loudspeaker of the array.

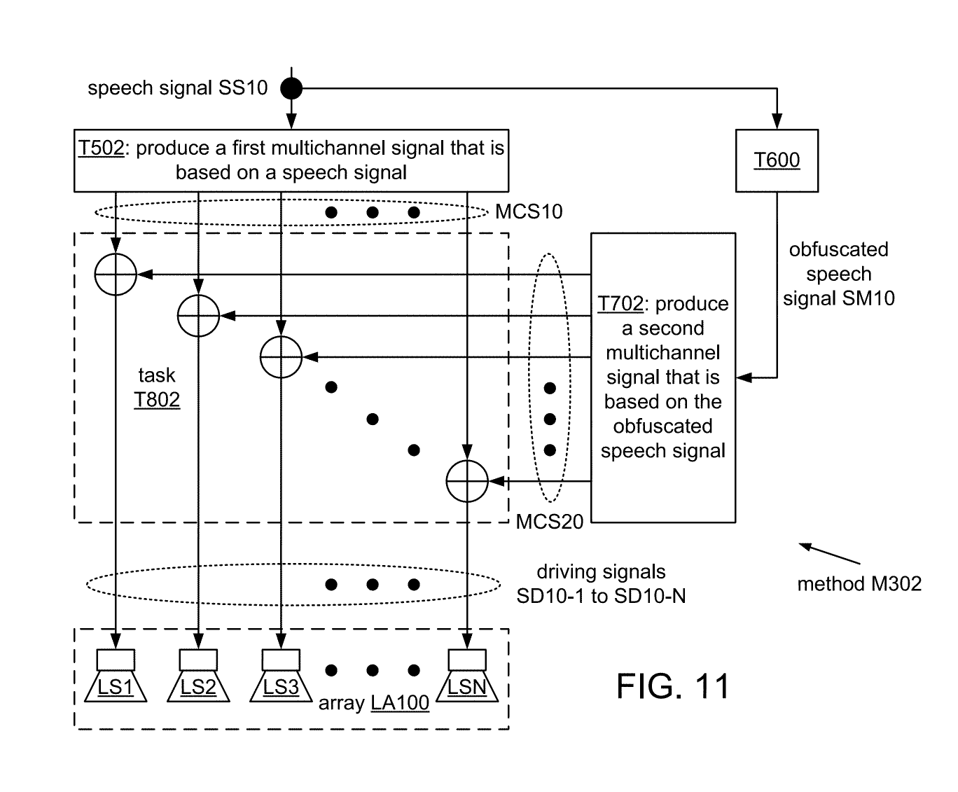

FIG. 11 illustrates an application of such an implementation M302 of method M300. In this example, an implementation T502 of task T500 produces an N-channel multichannel source signal MCS10 that is based on source signal SS10, and an implementation T702 of task T700 produces an N-channel masking signal MCS20 that is based on a noise signal. An implementation T802 of task T800 mixes respective pairs of channels of the two multichannel signals to produce a corresponding one of N driving signals SD10-1 to SD10-N for each loudspeaker LS1 to LSN of array LA100. It is also possible for signal MCS10 and/or signal MCS20 to have less than N channels. It is expressly noted that any of the implementations of method M300 described herein may be realized as implementations of M302 as well (i.e., such that task T500 is implemented to have at least the properties of task T502, and such that task T700 is implemented to have at least the properties of task T702).

It may be desirable to implement method M300 to produce the source component by inducing constructive interference in a desired direction of the produced sound field (e.g., in the first direction) while inducing destructive interference in other directions of the produced sound field (e.g., in the second direction). Such a technique may include implementing task T500 to produce the multichannel source signal by steering a beam in a desired source direction while creating a null (implicitly or explicitly) in another direction. A beam is defined as a concentration of energy along a particular direction relative to the emitter (e.g., the loudspeaker array), and a null is defined as a valley, along a particular direction relative to the emitter, in a spatial distribution of energy.

Task T500 may be implemented, for example, to produce the multichannel source signal by applying a spatially directive filter (the “source spatially directive filter”) to the speech signal. By appropriately weighting and/or delaying the speech signal to generate each channel of the multichannel source signal, such an implementation of task T500 may be used to obtain a desired spatial distribution of the source component within the produced sound field. Task T500 may be implemented to apply a precalculated filter, to select the source spatially directive filter from among a set of precalculated filters (e.g., according to a desired beam direction and/or width), or to calculate the coefficients of the source spatially directive filter (e.g., according to any of expressions (1)-(3b) below).

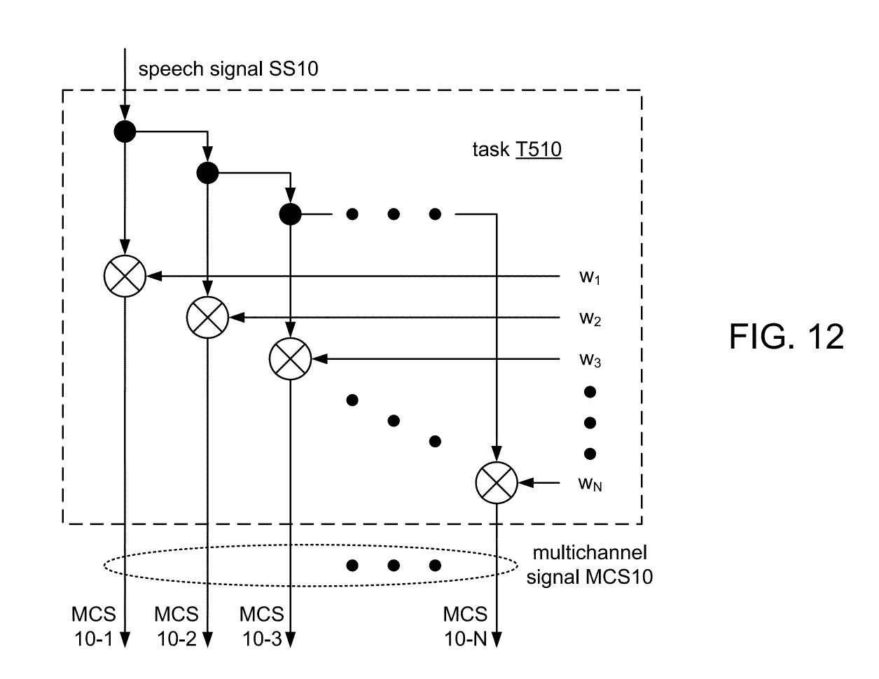

FIG. 12 shows a diagram of a frequency-domain implementation T510 of task T502 that is configured to produce each channel MCS10-1 to MCS10-N of multichannel source signal MCS10 as a product of speech signal SS10 and a corresponding one of the channels w₁ to w_{N} of the source spatially directive filter. Such multiplications may be performed serially (i.e., one after another) and/or in parallel (i.e., two or more at one time). In an equivalent time-domain implementation of task T502, the multipliers shown in FIG. 12 are implemented instead by convolution blocks.

Task T500 may be implemented according to a phased-array technique such that each channel of the multichannel source signal has a respective phase (i.e., time) delay. One example of such a technique is a delay-sum beamforming (DSB) filter. In such case, task T500 may be implemented to direct the source component in a desired source direction by applying a respective time delay to the speech signal to produce each channel of signal MCS10. For a case in which task T800 drives a uniformly spaced linear loudspeaker array, for example, the coefficients of channels w₁ to w_{N} of the source spatially directive filter may be calculated according to the following expression for a DSB filtering operation in the frequency domain:

$${w}_{n} ( f ) = exp ( - j \frac{2 π f}{c} ( n - 1 ) d cos {ϕ}_{s} ) \qquad ( 1 )$$

for 1≦n≦N, where d is the spacing between the centers of the radiating surfaces of adjacent loudspeakers in the array, N is the number of loudspeakers to be driven (which may be less than or equal to the number of loudspeakers in the array), f is a frequency bin index, c is the velocity of sound, and φₛ is the desired angle of the beam relative to the axis of the array (e.g., the desired source direction, or the desired direction of the main lobe of the source component). For an equivalent time-domain implementation of the filter configuration, elements w₁ to w_{N} may be implemented as corresponding delays. In either domain, task T500 may also include normalization of signal MCS10 by scaling each channel of signal MCS10 by a factor of 1/N (or, equivalently, scaling source signal SS10 by 1/N).

For a frequency f₁ at which the spacing d is equal to half of the wavelength λ (where λ=c/f₁), expression (1) reduces to the following expression:

wₙ(f₁)=exp(−jπ(n−1)cos φₛ). (2)

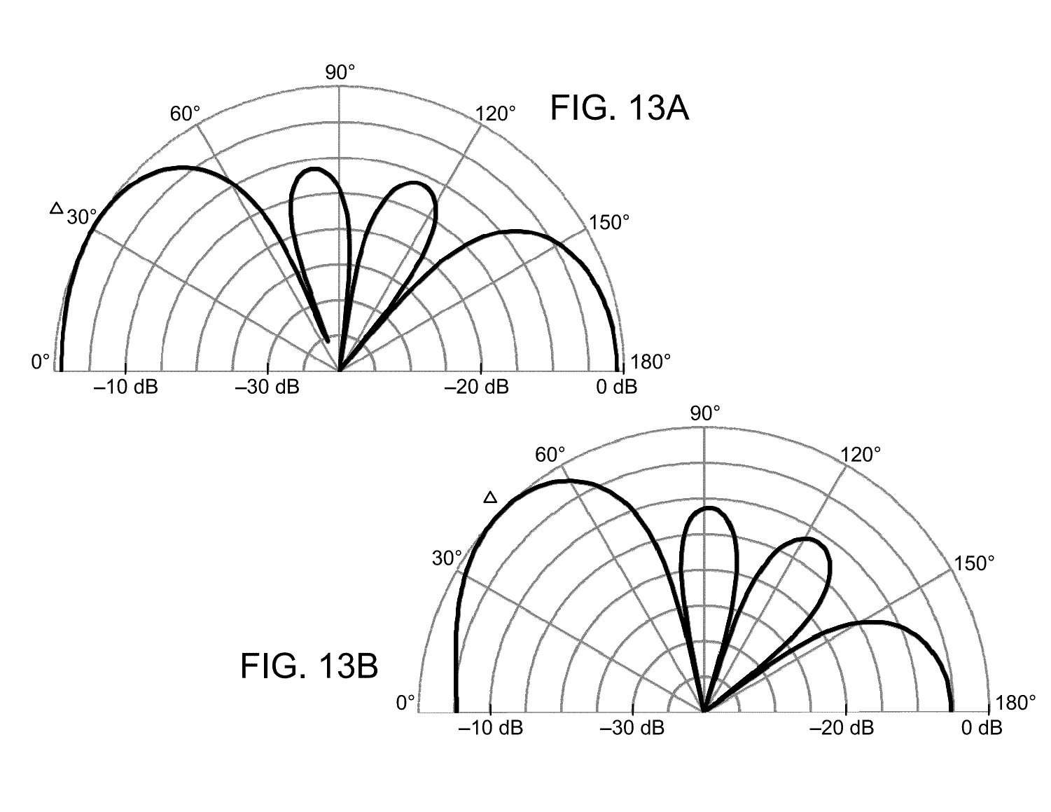

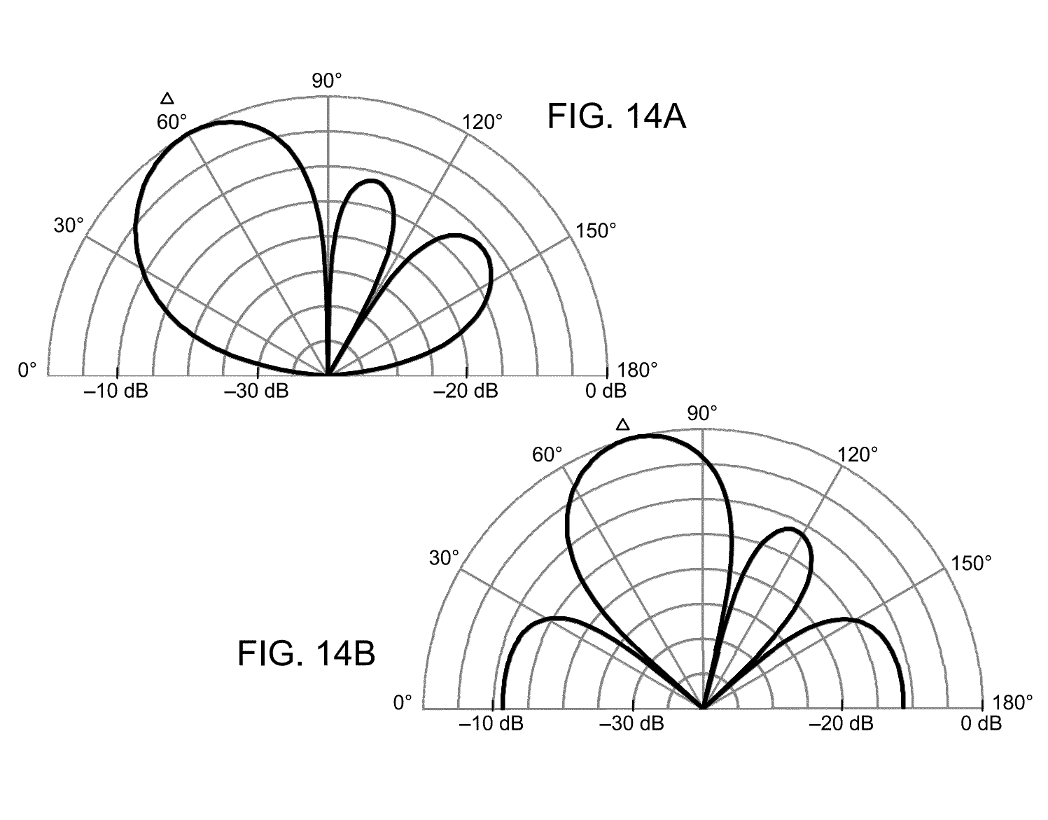

FIGS. 13A, 13B, 14A, and 14B show examples of the magnitude response with respect to direction (also called a beam pattern) of such a DSB filter at frequency f₁ for a four-element array, in which the orientation angle of the filter (i.e., angle φₛ, as indicated by the triangle in each figure) is thirty, forty-five, sixty, and seventy-five degrees, respectively.

It is noted that the filter beam patterns shown in FIGS. 13A, 13B, 14A, and 14B may differ at frequencies other than c/2d. To avoid spatial aliasing, it may be desirable to limit the maximum frequency of the source signal to c/2d (i.e., so that the spacing d is not more than half of the shortest wavelength of the signal). To direct a source component that includes high frequencies, it may be desirable to use a more closely spaced array.

It is also possible to implement method M300 to include multiple instances of task T500 such that portions of a directionally selective transducer (e.g., subarrays of array LA100) may be driven differently for different frequency ranges. Such an implementation may provide better directivity for wideband reproduction. In one example, a second instance of task T502 is implemented to produce an N/2-channel multichannel signal (e.g., using alternate ones of the channels w₁ to w_{N}) from a frequency band of the speech signal that is limited to a maximum frequency of c/4d, and this second multichannel signal is used to drive alternate loudspeakers of the array (i.e., a subarray that has an effective spacing of 2d).

It may be desirable to implement task T500 to apply different respective weights to channels of the multichannel source signal. For example, it may be desirable for the source spatially selective filter to include a spatial windowing function applied to the filter coefficients. Examples of such a windowing function include, without limitation, triangular and raised cosine (e.g., Hann or Hamming) windows. Use of a spatial windowing function tends to reduce both sidelobe magnitude and angular resolution (e.g., by widening the mainlobe).

In one example, the coefficients of each channel wₙ of the source spatially directive filter include a respective factor sₙ of a spatial windowing function. In such case, expressions (1) and (2) may be modified to the following expressions, respectively:

$$\begin{matrix}{w}_{n} ( f ) = {s}_{n} exp ( - j \frac{2 π f}{c} ( n - 1 ) d cos {ϕ}_{s} ) ; & ( 3 a ) \\ {w}_{n} ( {f}_{1} ) = {s}_{n} exp ( - jπ ( n - 1 ) cos {ϕ}_{s} ) . & ( 3 b )\end{matrix}$$

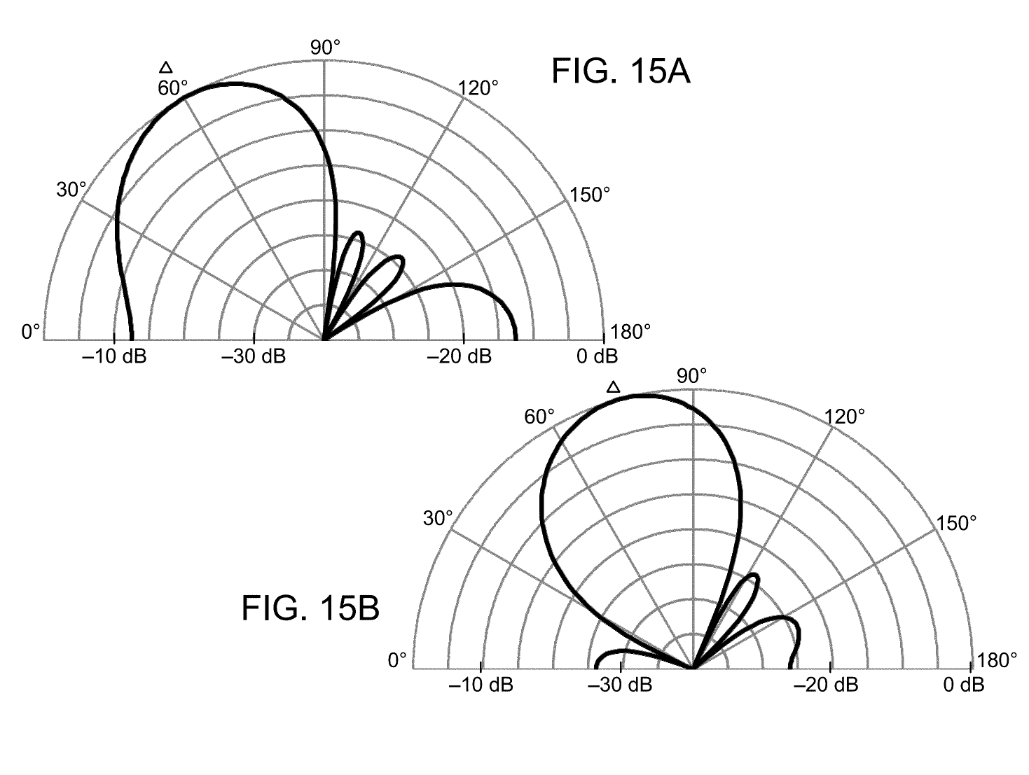

FIGS. 15A and 15B show examples of beam patterns at frequency f₁ for the four-element DSB filters of FIGS. 14A and 14B, respectively, according to such a modification in which the weights s₁ to s₄ have the values (2/3, 4/3, 4/3, 2/3), respectively.

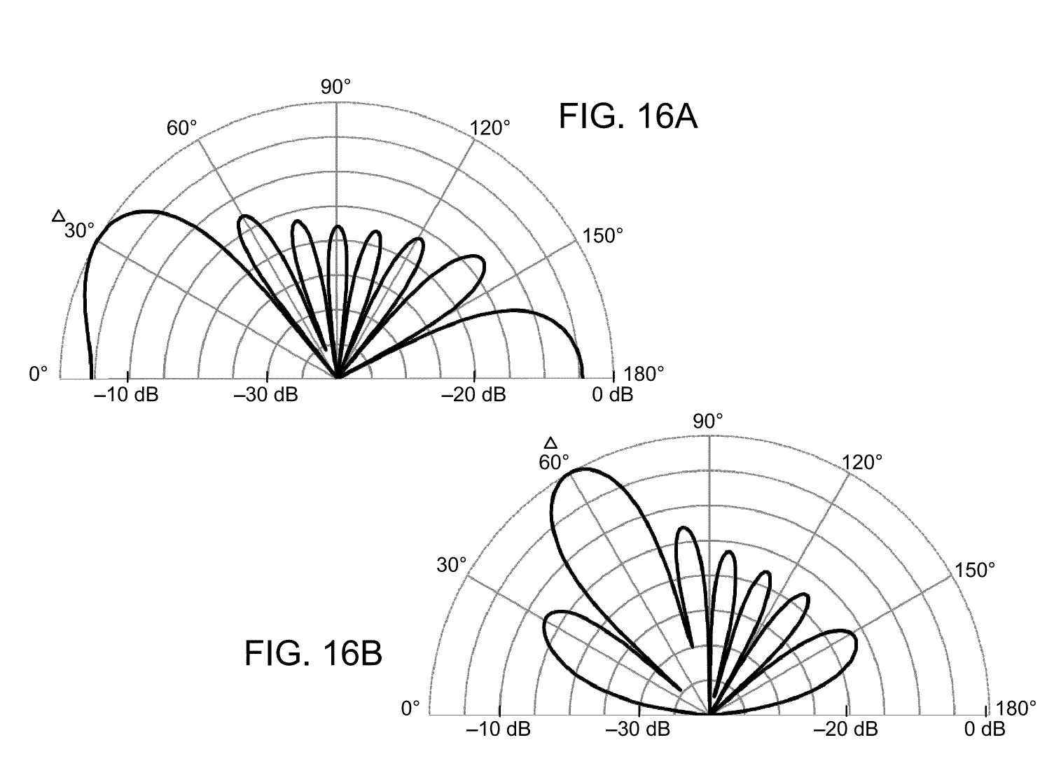

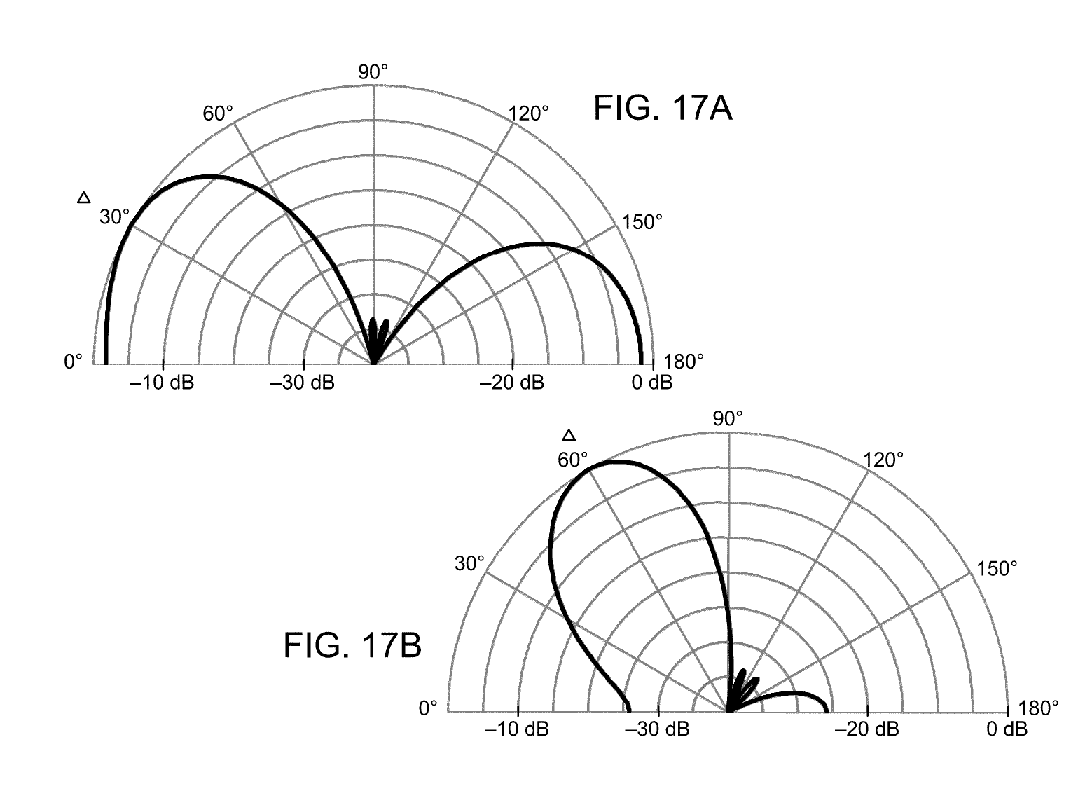

An array having more loudspeakers allows for more degrees of freedom and may typically be used to obtain a narrower mainlobe. FIGS. 16A and 16B show examples of a beam pattern of a DSB filter for an eight-element array, in which the orientation angle of the filter is thirty and sixty degrees, respectively. FIGS. 17A and 17B show examples of beam patterns for the eight-element DSB filters of FIGS. 16A and 16B, respectively, in which weights s₁ to s₈ as defined by the following Hamming windowing function are applied to the coefficients of the corresponding channels of the source spatially directive filter:

$${s}_{n} = 0.54 - 0.46 cos ( \frac{2 π ( n - 1 )}{N - 1} ) . \qquad ( 4 )$$

It may be desirable to implement task T500 and/or task T700 to apply a superdirective beamformer, which maximizes gain in a desired direction while minimizing the average gain over all other directions. Examples of superdirective beamformers include the minimum variance distortionless response (MVDR) beamformer (cross-covariance matrix), and the linearly constrained minimum variance (LCMV) beamformer. Other fixed or adaptive beamforming techniques, such as generalized sidelobe canceller (GSC) techniques, may also be used.

The design goal of an MVDR beamformer is to minimize the output signal power with the constraint min_{w} W^{H}Φ_{XX}W subject to W^{H}d=1, where W denotes the filter coefficient matrix, Φ_{XX} denotes the normalized cross-power spectral density matrix of the loudspeaker signals, and d denotes the steering vector. Such a beam design may be expressed as

$$W = \frac{{( {Γ}_{VV} + μ I )}^{- 1} d}{{{d}^{H} ( {Γ}_{VV} + μ I )}^{- 1} d} ,$$

where d^{T} is a farfield model for linear arrays that may be expressed as

d^{T}=[1, exp(−jΩfₛc⁻¹ cos(θ₀)),exp(−jΩfₛc⁻¹2l cos(θ₀)), . . . ,exp(−jΩfₛc⁻¹(N−1)cos(θ₀))],

and Γᵥ_{ₙ}ᵥ_{ₘ} is a coherence matrix whose diagonal elements are 1 and which may be expressed as

$${Γ}_{{V}_{n} {V}_{m}} = \frac{sin c ( \frac{Ω {f}_{s} {l}_{n m}}{c} )}{1 + \frac{{σ}^{2}}{{Φ}_{VV}}} ∀ n \neq m .$$

In these equations, μ denotes a regularization parameter (e.g., a stability factor), θ₀ denotes the beam direction, fₛ denotes the sampling rate, Ω denotes angular frequency of the signal, c denotes the speed of sound, l denotes the distance between the centers of the radiating surfaces of adjacent loudspeakers, lₙₘ denotes the distance between the centers of the radiating surfaces of loudspeakers n and m, Φ_{VV} denotes the normalized cross-power spectral density matrix of the noise, and σ² denotes transducer noise power.

Task T500 may be implemented to produce the multichannel source signal to obtain a desired spatial response with a linear loudspeaker array with uniform spacing, a linear loudspeaker array with nonuniform spacing, or a nonlinear (e.g., shaped) array, such as an array having more than one axis. In one example, task T500 is implemented to produce the multichannel source signal to obtain a desired spatial response with an array having more than one axis by using a pairwise beamforming-nullforming (BFNF) configuration as described herein with reference to a microphone array. Such an application may include a loudspeaker that is shared among two or more of the axes. Task T500 may also be performed using other directional field generation principles, such as a wave field synthesis (WFS) technique based on, e.g., the Huygens principle of wavefront propagation.

Task T800 drives the loudspeaker array, in response to the multichannel source and masking signals, to produce the sound field. Typically the produced sound field is a superposition of a source component based on the multichannel source signal and a masking component based on the masking signal. In such case, task T800 may be implemented to produce the source component of the sound field by driving the array in response to the multichannel source signal to create a corresponding beam of acoustic energy that is concentrated in the direction of the user and to create a valley in the beam response at other locations.

Task T800 may be configured to amplify, apply a gain to, and/or control a gain of the multichannel source signal, and/or to filter the multichannel source and/or masking signals. As shown in FIG. 11, task T800 may be implemented to mix each channel of the multichannel source signal with a corresponding channel of the multichannel masking signal to produce a corresponding one of a plurality N of driving signals SD10-1 to SD10-N. Task T800 may be implemented to mix the multichannel source and masking signals in the digital domain or in the analog domain. For example, task T800 may be configured to produce a driving signal for each loudspeaker by converting digital source and masking signals to analog, or by converting a digital mixed signal to analog. Such an implementation of task T800 may also apply each of the N driving signals to a corresponding loudspeaker of array LA100.

Additionally or in the alternative to mixing corresponding channels of the multichannel source and masking signals, task T800 may be implemented to drive different loudspeakers of the array to produce the source and masking components of the field. For example, task T800 may be implemented to drive a first plurality (i.e., at least two) of the loudspeakers of the array to produce the source component and to drive a second plurality (i.e., at least two) of the loudspeakers of the array to produce the masking component, where the first and second pluralities may be separate, overlapping, or the same.

Task T800 may also be implemented to perform one or more other audio processing operations on the mixed channels to produce the driving signals. Such operations may include amplifying and/or filtering one or more (possibly all) of the mixed channels. For example, it may be desirable to implement task T800 to apply an inverse filter to compensate for differences in the array response at different frequencies and/or to implement task T800 to compensate for differences between the responses of the various loudspeakers of the array. Alternatively or additionally, it may be desirable to implement task T800 to provide impedance matching to the loudspeakers of the array (and/or to an audio-frequency transmission path that leads to the loudspeaker array).

Task T500 may be implemented to produce the multichannel source signal according to a desired direction. As described above, for example, task T500 may be implemented to produce the multichannel source signal such that the resulting source component is oriented in a desired source direction. Examples of such source direction control include, without limitation, the following:

In a first example, task T500 is implemented such that the source component is oriented in a fixed direction (e.g., center zone). For example, task T510 may be implemented such that the coefficients of channels w₁ to w_{N} of the source spatially directive filter are calculated offline (e.g., during design and/or manufacture) and applied to the speech signal at run-time. Such a configuration may be suitable for applications such as listening to a recorded speech signal and browse-talk (i.e., web surfing while on a telephone call). Typical use scenarios include on an airplane, in a transportation hub (e.g., an airport or rail station), and at a coffee shop or café. Such an implementation of task T500 may be configured to allow selection (e.g., automatically according to a detected use mode, or by the user) among different source beam widths to balance privacy (which may be important for a telephone call) against sound pollution generation (which may be a problem for speakerphone use in close public areas).

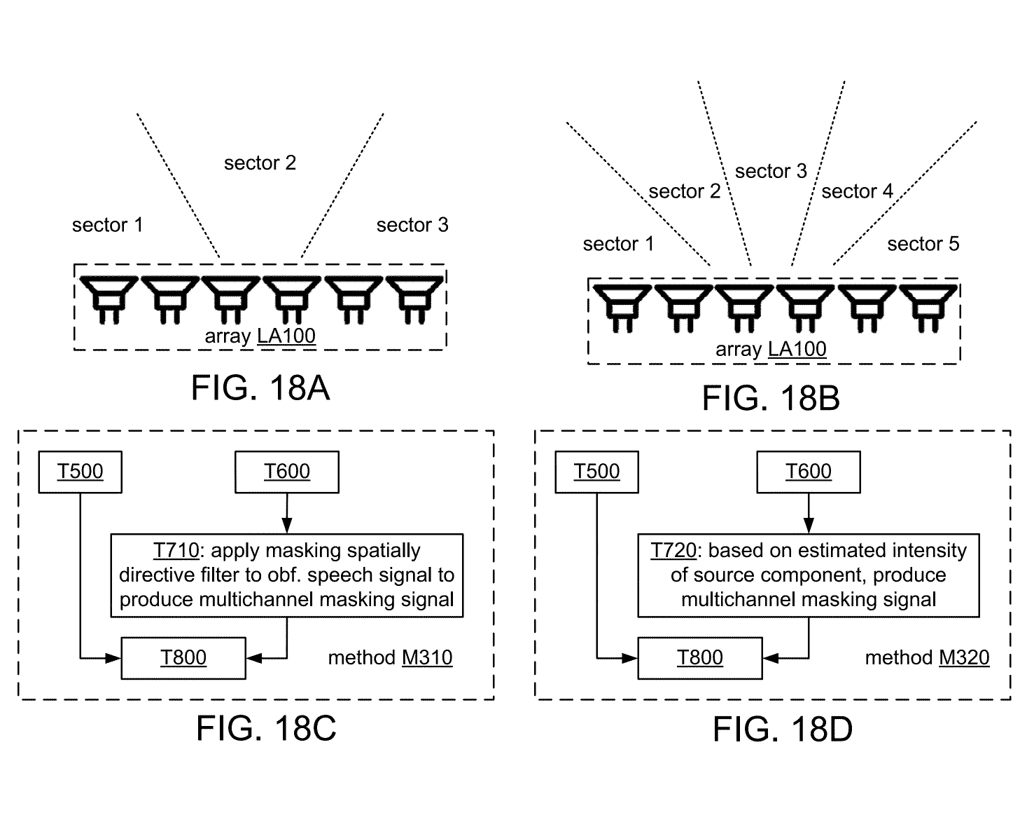

In a second example, task T500 is implemented such that the source component is oriented in a direction that is selected by the user from among two or more fixed options. For example, task T500 may be implemented such that the source component is oriented in a direction that corresponds to the user's selection from among a left zone, a center zone, and a right zone. In such case, task T510 may be implemented such that, for each direction to be selected, a corresponding set of coefficients for the channels w₁ to w_{N} of the source spatially directive filter is calculated offline (e.g., during design and/or manufacture) for selection and application to the speech signal at run-time. One example of corresponding respective directions for the left, center, and right zones (or sectors) in such a case is (45, 90, 135) degrees. Other examples include, without limitation, (30, 90, 150) and (60, 90, 120) degrees. FIGS. 18A and 18B show examples of schemes having three and five selectable fixed spatial sectors, respectively.

In a third example, task T500 is implemented such that the source component is oriented in a direction that is automatically selected from among two or more fixed options according to an estimated user position. Such a configuration may be suitable for a speakerphone application. For example, task T500 may be implemented such that the source component is oriented in a direction that corresponds to the user's estimated position from among a left zone, a center zone, and a right zone. In such case, task T510 may be implemented such that, for each direction to be selected, a corresponding set of coefficients for the channels w₁ to w_{N} of the source spatially directive filter is calculated offline (e.g., during design and/or manufacture) for selection and application to the speech signal at run-time. One example of corresponding respective directions for the left, center, and right zones in such a case is (45, 90, 135) degrees. Other examples include, without limitation, (30, 90, 150) and (60, 90, 120) degrees. It is also possible for such an implementation of task T500 to select among different source beam widths for the selected direction according to an estimated user range. For example, a more narrow beam may be selected when the user is more distant from the array (e.g., to obtain a similar beam width at the user's position at different ranges).

In a fourth example, task T500 is implemented such that the source component is oriented in a direction that may vary over time in response to changes in an estimated direction of the user. In such case, task T510 may be implemented to calculate the coefficients of the channels w₁ to w_{N} of the source spatially directive filter at run-time such that the orientation angle of the filter (i.e., angle φₛ) corresponds to the estimated direction of the user. Such an implementation of task T510 may be configured to perform an adaptive beamforming operation.

In a fifth example, task T500 is implemented such that the source component is oriented in a direction that is initially selected from among two or more fixed options according to an estimated user position (e.g., as in the third example above) and then adapted over time according to changes in the estimated user position (e.g., changes in direction and/or distance). In such case, task T510 may also be implemented to switch to (and then adapt) another of the fixed options in response to a determination that the current estimated direction of the user is within a zone corresponding to the new fixed option.

Generation of the multichannel source signal by task T500 leads to a concentration of energy of the source component in a source direction relative to an axis of the array (e.g., in the direction of angle φₛ). As shown in FIGS. 13A to 17B, lesser but potentially significant concentrations of energy of the source component may arise in other directions relative to the axis as well (“leakage directions”). These concentrations are typically caused by sidelobes in the response of the source spatially directive filter.

It may be desirable to implement task T700 to direct the masking component such that its intensity is higher in one direction than another. For example, task T700 may be implemented to produce the multichannel masking signal such that an intensity of the masking component is higher in the leakage direction than in the source direction. The source direction is typically the direction of a main lobe of the source component, and the leakage direction may be the direction of a sidelobe of the source component. A sidelobe is an energy concentration of the component that is not within the main lobe.

In one example, the leakage direction is determined as the direction of a sidelobe of the source component that is adjacent to the main lobe. In another example, the leakage direction is the direction of a sidelobe of the source component whose peak intensity is not less than (e.g., is greater than) the peak intensities of all other sidelobes of the source component.

In a further alternative, the leakage direction may be based on directions of two or more sidelobes of the source component. For example, these sidelobes may be the highest sidelobes of the source component, the sidelobes having estimated intensities not less than (alternatively, greater than) a threshold value, and/or the sidelobes that are closest in direction to the same side of the main lobe of the source component. In such case, the leakage direction may be calculated as an average direction of the sidelobes, such as a weighted average among two or more directions (e.g., each weighted by intensity of the corresponding sidelobe).

Selection of the leakage direction may be performed during a design phase, based on a calculated response of the source spatially directive filter and/or from observation of a sound field produced using such a filter. Alternatively, task T700 may be implemented to select the leakage direction at run-time, similarly based on such a calculation and/or observation.

It may be desirable to implement task T700 to produce the masking component by inducing constructive interference in a desired direction of the produced sound field (e.g., in a leakage direction) while inducing destructive interference in other directions of the produced sound field (e.g., in the source direction). Such a technique may include implementing task T700 to produce the multichannel masking signal by steering a beam in a desired masking direction (i.e., in a leakage direction) while creating a null (implicitly or explicitly) in another direction.

Task T700 may be implemented, for example, to produce the masking signal by applying a second spatially directive filter (the “masking spatially directive filter”) to the obfuscated speech signal. FIG. 18C shows a flowchart of an implementation M310 of method M300 that includes such an implementation T710 of task T700. By appropriately weighting and/or delaying the obfuscated speech signal to generate each channel of the multichannel masking signal (e.g., as described above with reference to the multichannel source signal and the source component in task T500), task T710 produces a masking signal that may be used to obtain a desired spatial distribution of the masking component within the produced sound field.

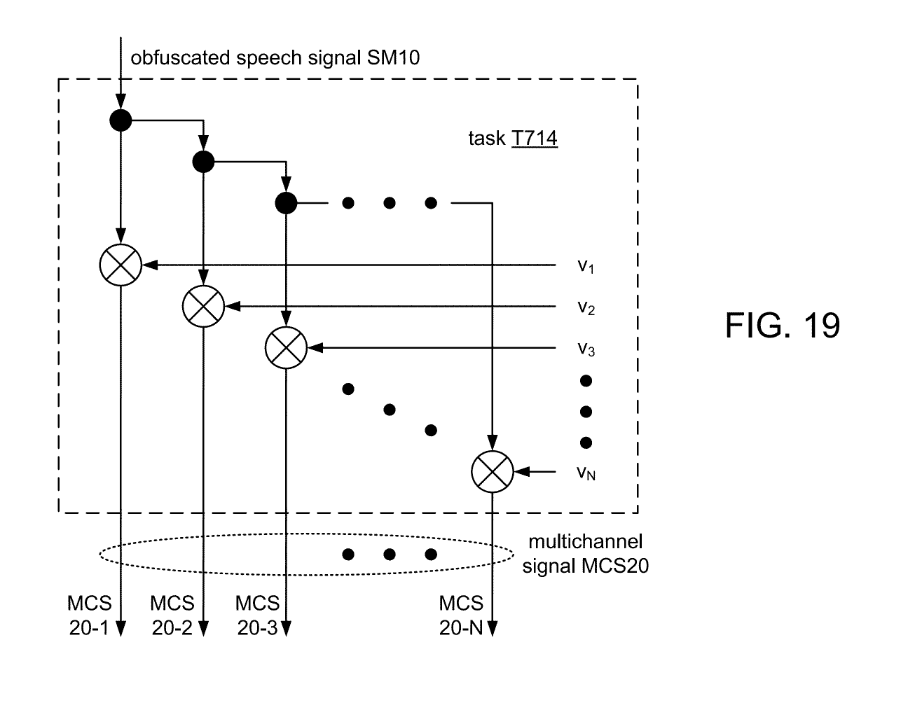

FIG. 19 shows a diagram of a frequency-domain implementation T714 of tasks T702 and T710 that is configured to produce each channel MCS20-1 to MCS20-N of masking signal MCS20 as a product of obfuscated speech signal SM10 and a corresponding one of filters v₁ to v_{N}. Such multiplications may be performed serially (i.e., one after another) and/or in parallel (i.e., two or more at one time). For an equivalent time-domain implementation, the multipliers shown in FIG. 19 may be implemented instead by convolution blocks.

Task T700 may be implemented according to a phased-array technique such that each channel of the masking signal has a respective phase (i.e., time) delay. For example, task T700 may be implemented to perform a DSB filtering operation to direct the masking component in the leakage direction by applying a respective time delay to the noise signal to produce each channel of signal MCS20. For a case in which task T800 drives a uniformly spaced linear loudspeaker array, for example, the coefficients of channels v₁ to v_{N} of the masking spatially directive filter may be calculated according to an expression for a DSB filtering operation in the frequency domain such as expression (1) or (3a) above, where the angle φₛ is replaced by the desired angle φₘ of the beam relative to the axis of the array (e.g., the leakage direction).

To avoid spatial aliasing, it may be desirable to limit the maximum frequency of the noise signal to c/2d. It is also possible to implement method M300 to include multiple instances of task T700 such that subarrays of array LA100 are driven differently for different frequency ranges.

The masking component may include more than one subcomponent. For example, the masking spatially directive filter may be configured such that the masking component includes a first masking subcomponent whose energy is concentrated in a beam on one side of the main lobe of source component, and a second masking subcomponent whose energy is concentrated in a beam on the other side of the main lobe of the source component. The masking component typically has a null in the source direction.

Examples of masking direction control that may be performed by respective implementations of task T700 include, without limitation, the following:

1) For a case in which the direction of the source component is fixed (e.g., determined during a design phase), it may be desirable also to fix (i.e., to precalculate) the masking direction.

2) For cases in which the direction of the source component is selected (e.g., by the user or automatically) from among several fixed options, it may be desirable for each of such fixed options to also indicate a corresponding masking direction. It may also be desirable to allow for multiple masking options for a single source direction (to allow selection among different respective masking component patterns, for example, for a case in which source beam width is selectable).

3) For a case in which the source component is adapted according to a direction that may vary over time, it may be desirable to select a corresponding masking direction from among several preset options and/or to adapt the masking direction according to the changes in the source direction.

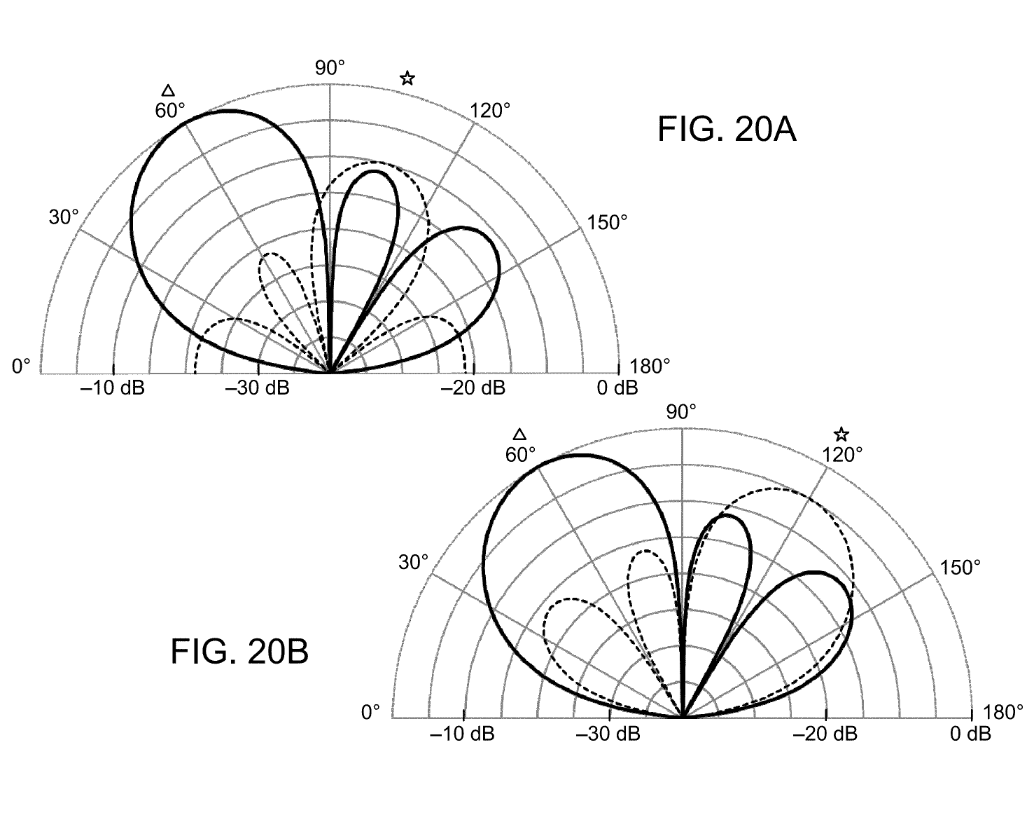

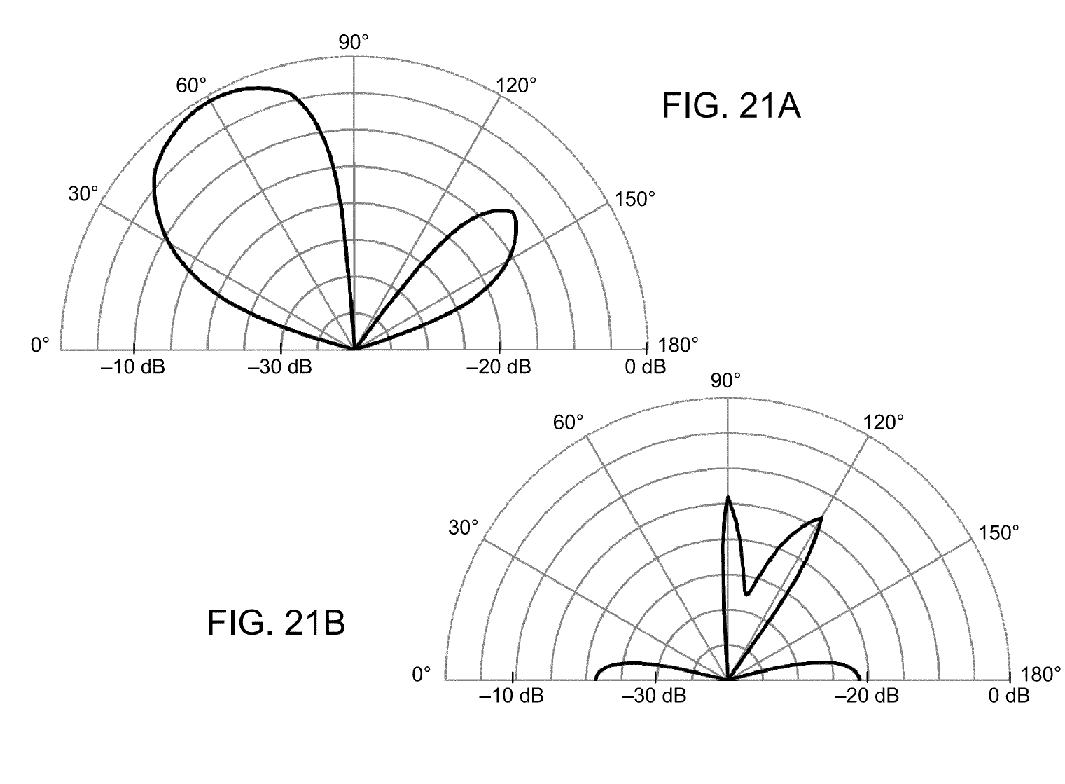

It may be desirable to design the masking spatially directive filter to have a response that is similar to the response of the source spatially selective filter in one or more leakage directions and has a null in the source direction. FIG. 20A shows an example of a beam pattern of a DSB filter (solid line, at frequency f₁) for driving a four-element array to produce a source component. In this example, the orientation angle of the filter (i.e., angle φₛ, as indicated by the triangle) is sixty degrees. FIG. 20A also shows an example of a beam pattern of a DSB filter (dashed line, also at frequency f₁) for driving the four-element array to produce a masking component. In this example, the orientation angle of the filter (i.e., angle φₘ, as indicated by the star) is 105 degrees, and the peak level of the masking component is ten decibels less than the peak level of the source component. FIGS. 21A and 21B show results of subtracting each beam pattern from the other, such that FIG. 21A shows the unmasked portion of the source component in the resulting sound field, and FIG. 21B shows the excess portion of the masking component in the resulting sound field.

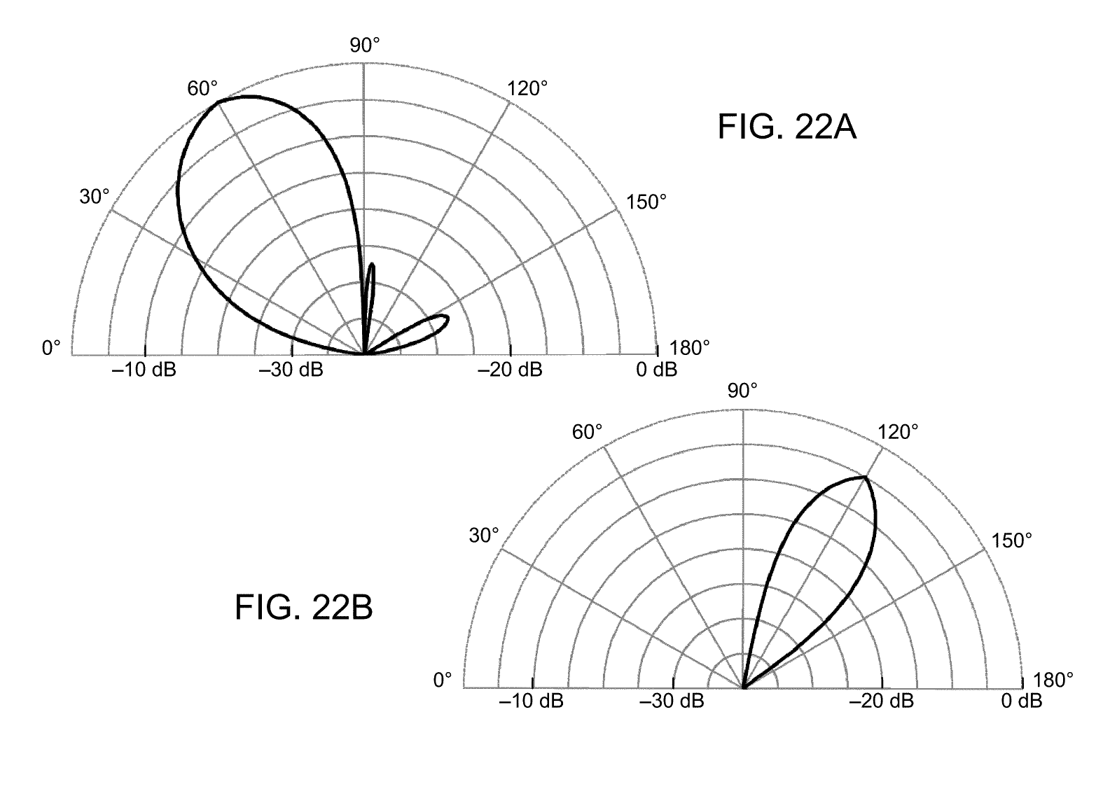

FIG. 20B shows an example of a beam pattern of a DSB filter (solid line, at frequency f₁) for driving a four-element array to produce a source component. In this example, the orientation angle of the filter (i.e., angle φₛ, as indicated by the triangle) is sixty degrees. FIG. 20B also shows an example of a beam pattern of a DSB filter (dashed line, also at frequency f₁) for driving the four-element array to produce a masking component. In this example, the orientation angle of the filter (i.e., angle φₘ, as indicated by the star) is 120 degrees, and the peak level of the masking component is five decibels less than the peak level of the source component. FIGS. 22A and 22B show results of subtracting each beam pattern from the other, such that FIG. 22A shows the unmasked portion of the source component in the resulting sound field, and FIG. 22B shows the excess portion of the masking component in the resulting sound field.

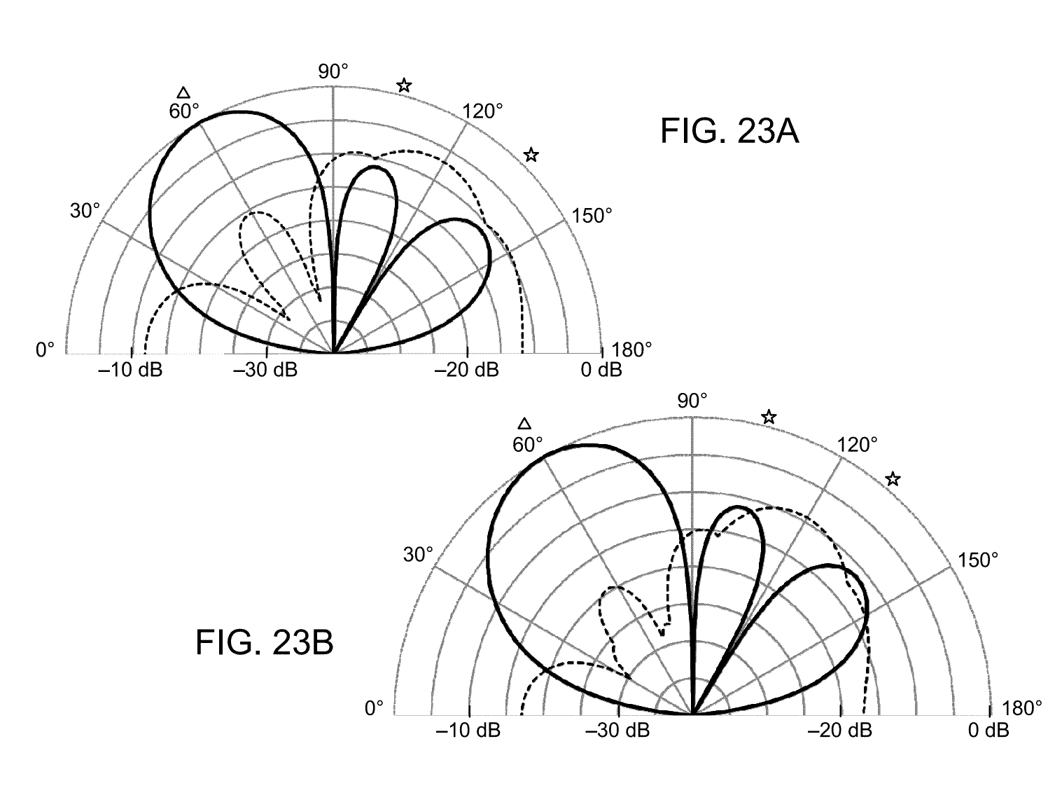

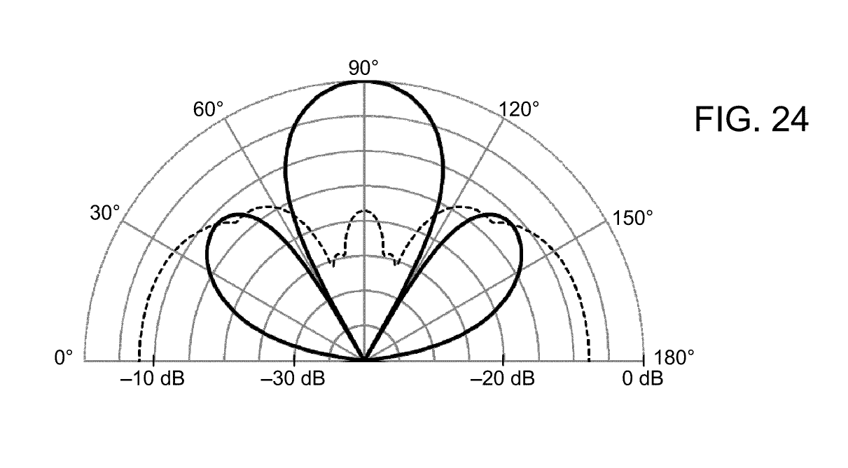

FIG. 23A shows an example of a beam pattern of a DSB filter (solid line, at frequency f₁) for driving a four-element array to produce a source component. In this example, the orientation angle of the filter (i.e., angle φₛ, as indicated by the triangle) is sixty degrees. FIG. 23A also shows an example of a composite beam pattern (dashed line, also at frequency f₁) that is a sum of two DSB filters for driving the four-element array to produce a masking component. In this example, the orientation angle of the first masking subcomponent (i.e., angle φₘ₁, as indicated by a star) is 105 degrees, and the peak level of this component is ten decibels less than the peak level of the source component. The orientation angle of the second masking subcomponent (i.e., angle φₘ₂, as indicated by a star) is 135 degrees, and the peak level of this component is also ten decibels less than the peak level of the source component. FIG. 23B shows a similar example in which the first masking subcomponent is oriented at 105 degrees with a peak level that is fifteen dB below the source peak, and the second masking subcomponent is oriented at 130 degrees with a peak level that is twelve dB below the source peak. FIG. 24 shows an example in which the orientation angle of the filter is ninety degrees, the first masking subcomponent is oriented at 35 degrees with a peak level that is twelve dB below the source peak, and the second masking subcomponent is oriented at 145 degrees with a peak level that is twelve dB below the source peak.

As illustrated in FIGS. 7-9, it may be desirable to produce a masking component whose intensity is related to a degree of leakage of the source component. For example, it may be desirable to implement task T200 to produce the masking signal based on an estimated intensity of the source component. FIG. 18D shows a flowchart of an implementation M320 of method M300 that includes such an implementation T720 of task T700.

The estimated intensity of the source component in a given direction φ may be based on an estimated response of the source spatially directive filter in that direction, which is typically expressed relative to an estimated peak response of the filter (e.g., the estimated response of the filter in the source direction). Task T720 may be implemented to apply a gain factor value to the obfuscated speech signal that is based on a local maximum of an estimated response of the source spatially directive filter in a direction other than the source direction (e.g., in the leakage direction). For example, task T720 may be implemented to apply a gain factor value that is based on the maximum sidelobe peak intensity of the filter response. In another example, the value of the gain factor is based on a maximum of the estimated filter response in a direction that is at least a minimum angular distance (e.g., ten or twenty degrees) from the source direction.

For a case in which a source spatially directive filter of task T500 comprises channels w₁ to w_{N} as in expression (1) above, the response H_{φs}(tp, f) of the filter, at angle φ and frequency f and relative to the response at source direction angle φₛ, may be estimated as a magnitude of a sum of the relative responses of the channels w₁ to w_{N}. Such an estimated response may be expressed in decibels as:

$${H}_{ϕ s} ( ϕ , f ) = 20 {log}_{10} \vert \frac{1}{N} {\sum }_{n = 1}^{N} exp ( - j \frac{2 π fd}{c} ( n - 1 ) ( cos ϕ - cos {ϕ}_{s} ) ) \vert . \qquad ( 5 )$$

Similar application of the principle of this example to calculate an estimated response for a spatially directive filter that is otherwise expressed will be easily understood.

Such calculation of a filter response may be performed according to a desired resolution of angle φ and frequency f. Alternatively, it may be decided for some applications that calculation of the response at a single value of frequency f (e.g., frequency f₁) is sufficient. Such calculation may also be performed for each of a plurality of source spatially selective filters, each oriented in a different corresponding source direction (e.g., for each of a set of fixed options as described above with reference to examples 1, 2, 3, and 5 of task T500), such that task T720 selects the estimated response corresponding to the current source direction at run-time.

Calculating a filter response as defined by the values of its coefficients (e.g., as described above with reference to expression (5)) produces a theoretical result that may differ from the actual response of the device with respect to direction (and frequency) as observed in service. It may be expected that in-service masking performance may be improved by compensating for such difference. For example, the response of the source spatially directive filter with respect to direction (and frequency, if desired) may be estimated by measuring the intensity distribution of an actual sound field that is produced using a copy of the filter. Such direct measurement of the estimated intensity may also be expected to account for other effects that may be observed in service, such as a response of the loudspeaker array, acoustic reflectance of the surfaces of the device, resonances of the housing, etc. The response of the source spatially directive filter may be estimated and stored before run-time, such as during design and/or manufacture, to be accessed by task T720 at run-time.

Task T720 may be implemented to calculate the gain factor such that the masking component has the same intensity in the leakage direction as the source component, or to obtain a different relation between these intensities (e.g., based on a loudness weighting function or other perceptual response function, such as an A-weighting curve). The value of the gain factor may also be based on an estimated intensity of the source component in one or more other directions. For example, the gain factor value may be based on estimated filter responses at two or more source sidelobes (e.g., relative to the source main lobe level). In such case, the two or more sidelobes may be selected as the highest sidelobes, the sidelobes having estimated intensities not less than (alternatively, greater than) a threshold value, and/or the sidelobes that are closest in direction to the main lobe. The gain factor value (which may be precalculated, or calculated at run-time by task T720) may be based on an average of the estimated responses at the two or more sidelobes.

The source component may have a frequency distribution that differs from one direction to another. Such variations may arise from task T500 (e.g., from the operation of applying a source spatially directive filter to generate the source component). Such variations may also arise from the response of the audio output stage and/or loudspeaker array. It may be desirable to produce the masking component according to an estimation of frequency- and direction-dependent variations in the source component. For example, it may be desirable to implement task T720 to apply different respective gain factors to different frequency bands of the obfuscated speech signal, where the gain factors are based on estimated intensities of the source component in those frequency bands and on a desired masking level.

Method M300 may be used in any of a wide variety of different applications. For example, method M300 may be used to reproduce the far-end communications signal in a two-way voice communication, such as a telephone call. In such a case, a primary concern may be to protect the privacy of the user (e.g., by obscuring the sidelobes of the source component). It may be desirable for the device to activate a privacy masking mode in response to an incoming and/or an outgoing telephone call.

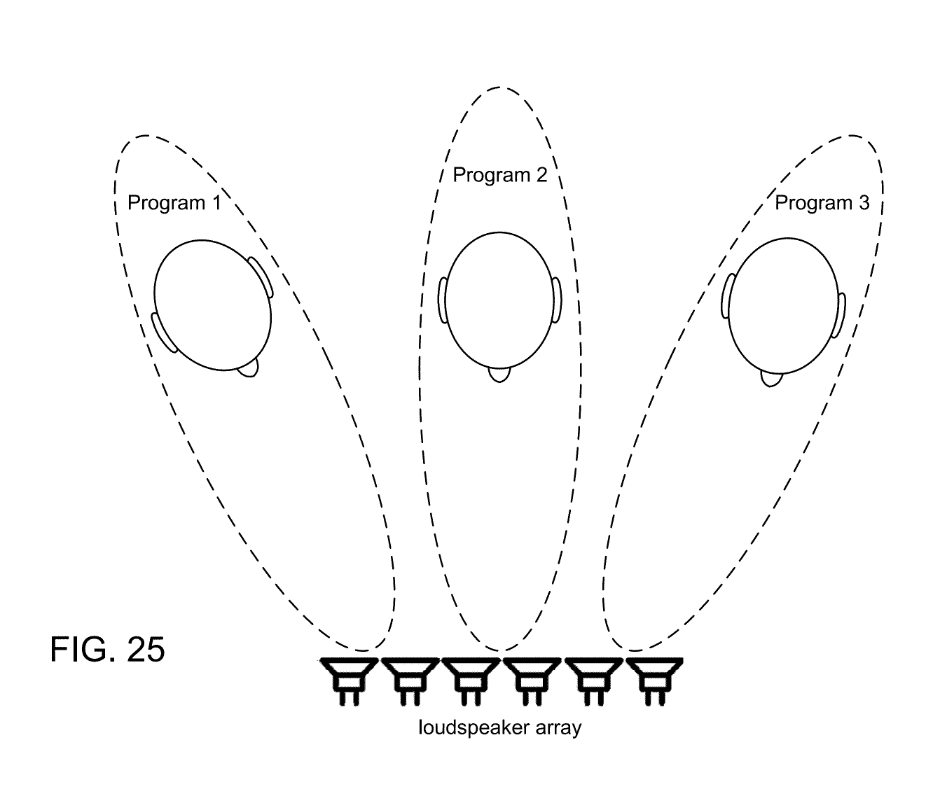

Method M300 may also be implemented to drive a loudspeaker array to generate a sound field that includes more than one source component. FIG. 25 shows an example of such a multi-source use case in which a loudspeaker array (e.g., array LA100) is driven to generate several source components simultaneously. In this case, each of the source components is based on a different source signal and is directed in a different respective direction.

In one example of a multi-source use case, method M300 is implemented to generate source components having unrelated audio content into different respective directions. For example, each of two or more of the source components may carry far-end audio content for a different voice communication (e.g., telephone call). Alternatively or additionally, each of two or more of the source components may include an audio track for a different respective media reproduction (e.g., music, video program, etc.).

For a case in which multiple source signals are supported, each source component may be oriented in a respective direction that is fixed (e.g., selected, by a user or automatically, from among two or more fixed options), as described herein with reference to task T500. Alternatively, each of at least one (possibly all) of the source components may be oriented in a respective direction that may vary over time in response to changes in an estimated direction of a corresponding user. Typically it is desirable to implement independent direction control for each source, such that each source component or beam is steered independently of the other(s) (e.g., by a corresponding instance of task T500).

In a typical multi-source application, it may be desirable to provide about thirty or forty to sixty degrees of separation between the directions of orientation of adjacent source components. One typical application is to provide different respective source components to each of two or more users who are seated shoulder-to-shoulder (e.g., on a couch) in front of the loudspeaker array. At a typical viewing distance of 1.5 to 2.5 meters, the span occupied by a viewer is about thirty degrees. With an array of four microphones, a resolution of about fifteen degrees may be possible. With an array having more microphones, a more narrow beam may be obtained.

As for a single-source case, privacy may be a concern for multi-source cases, especially if at least one of the source signals is a far-end voice communication (e.g., a telephone call). For a typical multiple-source case, however, leakage of one source component to another may be a greater concern, as each source component is potentially an interferer to other source components being produced at the same time. Accordingly, it may be desirable to generate a source component to have a null in the direction of another source component. For example, each source beam may be directed to a respective user, with a corresponding null being generated in the direction of each of one or more other users. Such design will typically cope with a “waterbed” effect, as the energy suppressed by creating a null on one side of a beam is likely to re-emerge as a sidelobe on the other side. The beam and null (or nulls) of a source component may be designed together or separately. It may be desirable to direct two or more narrow nulls of a source component next to each other to obtain a broader null. For each source signal to be obfuscated, an instance of method M300 may be performed to produce a corresponding source component and a masking component according to an estimated spatial distribution of the source component.

It may be desirable to implement method M300 to adapt the direction of the source component, and/or the direction of the masking component, in response to changes in the location of the user. For a multiple-user case, it may be desirable to implement method M300 to perform such adaptation individually for each of two or more users. In order to determine the respective source and/or masking directions, such a method may be implemented to perform user tracking.

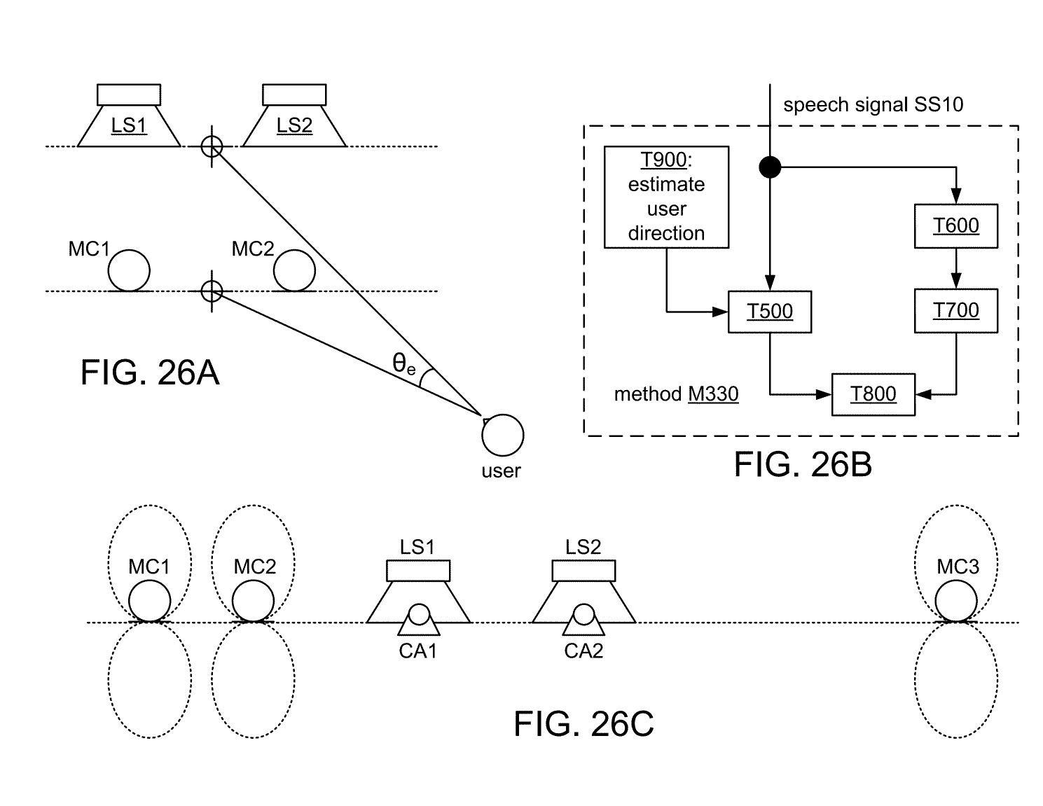

FIG. 26B shows a flowchart of an implementation M330 of method M300 that includes a task T900, which estimates a direction of each of one or more users (e.g., relative to the loudspeaker array). In this case, task T500 is implemented to direct the source component in the estimated user direction. Any among methods M310 and M320 may be realized as an implementation of method M330 (e.g., including an instance of task T900 as described herein). Task T900 may be configured to perform active user tracking by using, for example, radar and/or ultrasound. Additionally or alternatively, such a task may be configured to perform passive user tracking based on images from a camera (e.g., an optical, infrared, and/or stereoscopic camera). For example, such a task may include face tracking and/or user recognition.

Additionally or in the alternative, task T900 may be configured to perform passive tracking by applying a multi-microphone speech tracking algorithm to a multichannel sound signal produced by a microphone array (e.g., in response to sound emitted by the user or users). Examples of multi-microphone approaches to localization of one or more sound sources include directionally selective filtering operations, such as beamforming (e.g., filtering a sensed multichannel signal in parallel with several beamforming filters that are each fixed in a different direction, and comparing the filter outputs to identify the direction of arrival of the speech), blind source separation (e.g., independent component analysis, independent vector analysis, and/or a constrained implementation of such a technique), and estimating direction-of-arrival by comparing differences in level and/or phase between a pair of channels of the multichannel microphone signal. Such a task may include performing an echo cancellation operation on the multichannel microphone signal to block sound components that were produced by the loudspeaker array and/or performing a voice recognition operation on at least one channel of the multichannel microphone signal.

For accurate tracking results, it may be desirable for the microphone array (or other sensing device) to be aligned in space with the loudspeaker array in a reciprocal arrangement. In an ideally reciprocal arrangement, the direction to a point source P as indicated by a sensing device (e.g., a microphone array and associated tracking logic) is the same as the source direction used to direct a beam from the loudspeaker array to the point source P. A reciprocal arrangement may be used to create the privacy zones (e.g., by beamforming and nullforming) at the actual locations of the users. If the sensing and emitting arrays are not arranged reciprocally, the accuracy of creating a beam or null for designated source locations may be unacceptable. The quality of the null especially may suffer from such a mismatch, as a nullforming operation typically requires a higher level of accuracy than a comparable beamforming operation.

FIG. 26A shows a top view of a misaligned arrangement of a sensing array of microphones MC1, MC2 and an emitting array of loudspeakers LS1, LS2. For each array, the crosshair indicates the reference point with respect to which the angle between source direction and array axis is defined. In this example, error angle θₑ should be equal to zero for perfect reciprocity. To be reciprocal, the axis of at least one microphone pair should be aligned with and close enough to the axis of the loudspeaker array.

FIG. 26C shows an example of a multi-sensory reciprocal arrangement of transducers that may be used for beamforming and nullforming. In this example, the array of microphones MC1, MC2, MC3 is arranged along the same axis as the array of loudspeakers LS1, LS2. Feedback (e.g., echo) may arise if the microphones and loudspeakers are in close proximity, and it may be desirable for each microphone to have a minimal response in a side direction and to be located at some distance from the loudspeakers (e.g., within a far-field assumption). In this example, each microphone has a figure-eight gain response pattern that is concentrated in a direction perpendicular to the axis. The subarray of closely spaced microphones MC1 and MC2 has directional capability at high frequencies, due to a high spatial aliasing frequency. The subarrays of microphones MC1, MC3 and MC2, MC3 have directional capability at lower frequencies, due to a larger microphone spacing. This example also includes stereoscopic cameras CA1, CA2 in the same locations as the loudspeakers, because of the much shorter wavelength of light. Such close placement is possible with the cameras because echo is not a problem between the loudspeakers and cameras.

With an array of many microphones, a narrow beam may be produced. With a four-microphone array, for example, a resolution of about fifteen degrees is possible. For a typical television viewing distance of two meters, a span of fifteen degrees corresponds to a shoulder-to-shoulder width, and a span of thirty degrees corresponds to a typical angle between the directions of adjacent users seated on a couch. A typical application is to provide forty to sixty degrees between the directions of adjacent source beams.

It may be desirable to direct two or more narrow nulls together to obtain a broad null. The beam and nulls may be designed together or separately. Such design will typically cope with a “waterbed” effect, as creating a null on one side is likely to create a sidelobe on the other side.

As described above, it may be desirable to implement method M300 to support privacy zones for multiple listeners. In such an implementation of method M330, task T900 may be implemented to track multiple users. Multiple source beams may be directed to respective users, with corresponding nulls being generated in other user directions.

Any beamforming method may be used to estimate the direction of each of one or more users as described above. For example, a reciprocal implementation of a method used to generate the source and/or masking components may be applied.

For a one-dimensional (1-D) array of microphones, a direction of arrival (DOA) for a source may be easily defined in a range of, for example, −90° to +90°. For an array that includes more than two microphones at arbitrary relative locations (e.g., a non-coaxial array), it may be desirable to use a straightforward extension of one-dimensional principles as described above, e.g. (θ1, θ2) in a two-pair case in two dimensions; (θ1, θ2, θ3) in a three-pair case in three dimensions, etc. A key problem is how to apply spatial filtering to such a combination of paired 1-D DOA estimates.

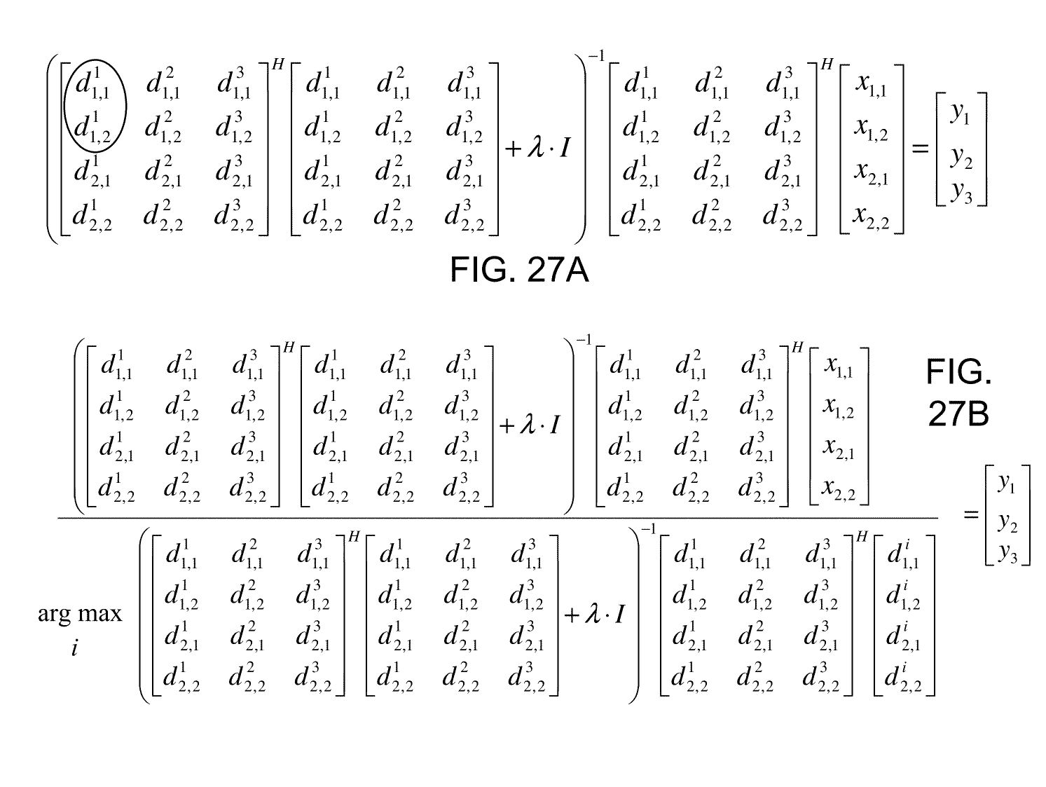

FIG. 27A shows an example of a straightforward one-dimensional (1-D) pairwise beamforming-nullforming (BFNF) configuration that is based on robust 1-D DOA estimation. In this example, the notation d_{i,j}^{k} denotes microphone pair number i, microphone number j within the pair, and source number k, such that each pair [d_{i,1}^{k} d_{i,2}^{k}]^{T} represents a steering vector for the respective source and microphone pair (the ellipse indicates the steering vector for source 1 and microphone pair 1), and λ denotes a regularization factor. The number of sources is not greater than the number of microphone pairs. Such a configuration avoids a need to use all of the microphones at once to define a DOA.

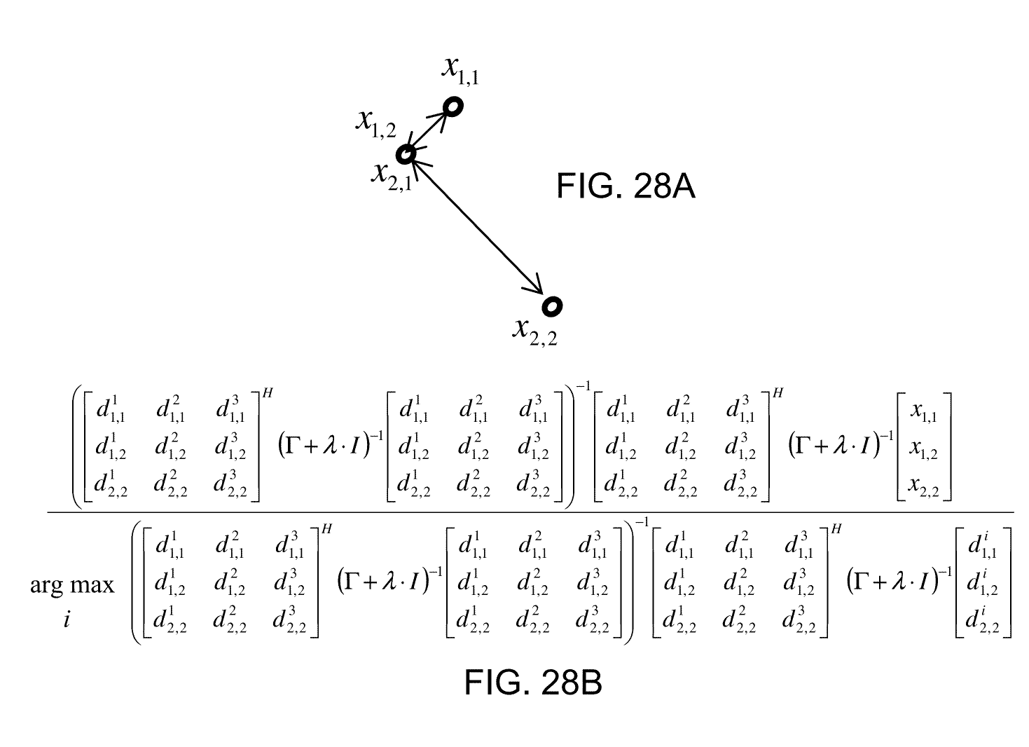

We may apply a beamformer/null beamformer (BFNF) as shown in FIG. 27A by augmenting the steering vector for each pair. In this figure, A^{H} denotes the conjugate transpose of A, x denotes the microphone channels, and y denotes the spatially filtered channels. Using a pseudo-inverse operation A⁺=(A^{H}A)⁻¹A^{H} as shown in FIG. 27A allows the use of a non-square matrix. For a three-microphone case (i.e., two microphone pairs) as illustrated in FIG. 28A, for example, the number of rows 2×2=4 instead of 3, such that the additional row makes the matrix non-square.

As the approach shown in FIG. 27A is based on robust 1-D DOA estimation, complete knowledge of the microphone geometry is not required, and DOA estimation using all microphones at the same time is also not required. FIG. 27B shows an example of the BFNF of FIG. 27A that also includes a normalization (i.e., by the denominator) to prevent an ill-conditioned inversion at the spatial aliasing frequency (i.e., the wavelength that is twice the distance between the microphones).

FIG. 28B shows an example of a pair-wise normalized MVDR (minimum variance distortionless response) BFNF, in which the manner in which the steering vector (array manifold vector) is obtained differs from the conventional approach. In this case, a common channel is eliminated due to sharing of a microphone between the two pairs (e.g., the microphone labeled as x_{1,2} and x_{2,1} in FIG. 28A). The noise coherence matrix Γ may be obtained either by measurement or by theoretical calculation using a sinc function. It is noted that the examples of FIGS. 27A, 27B, and 28B may be generalized to an arbitrary number of sources N such that N<=M, where M is the number of microphones (or, reciprocally, the number of loudspeakers).

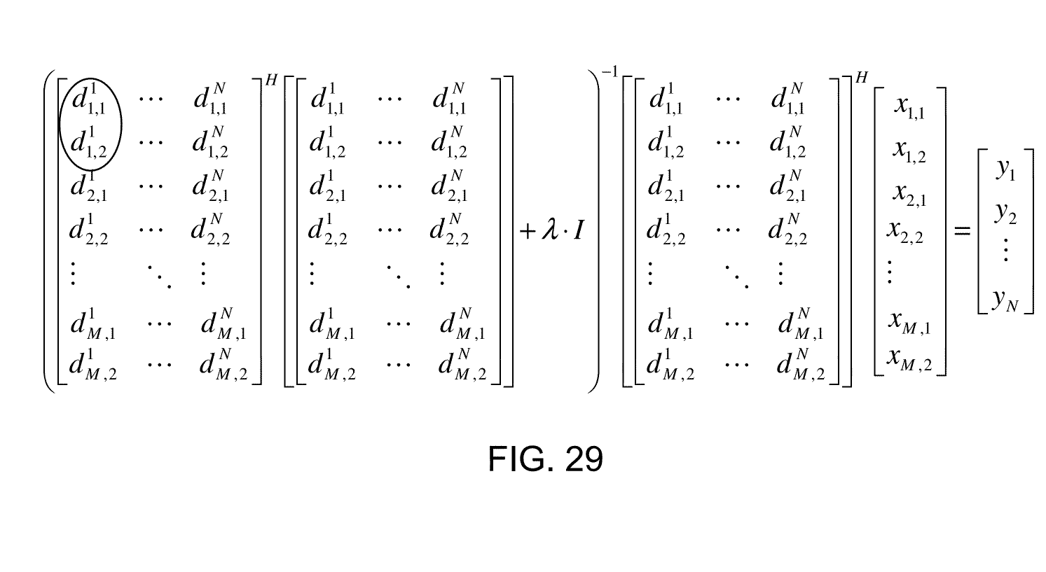

FIG. 29 shows another example that may be used if the matrix A^{H}A is not ill-conditioned, which may be determined using a condition number or determinant of the matrix. In this example, the notation is as in FIG. 27A, and the number of sources N is not greater than the number of microphone pairs M. If the matrix is ill-conditioned, it may be desirable to bypass one microphone signal for that frequency bin for use as the source channel, while continuing to apply the method to spatially filter other frequency bins in which the matrix A^{H}A is not ill-conditioned. This option saves computation for calculating a denominator for normalization. The methods in FIGS. 27A-29 demonstrate BFNF techniques that may be applied independently at each frequency bin. The steering vectors are constructed using the DOA estimates for each frequency and microphone pair as described herein. For example, each element of the steering vector for pair p and source n for DOA θᵢ, frequency f, and microphone number m (1 or 2) may be calculated as

$${d}_{p , m}^{n} = exp ( \frac{- j ω {f}_{s} ( m - 1 ) {l}_{p}}{c} cos {θ}_{i} ) ,$$

where lₚ indicates the distance between the microphones of pair p (reciprocally, between a pair of loudspeakers), w indicates the frequency bin number, and fₛ indicates the sampling frequency.

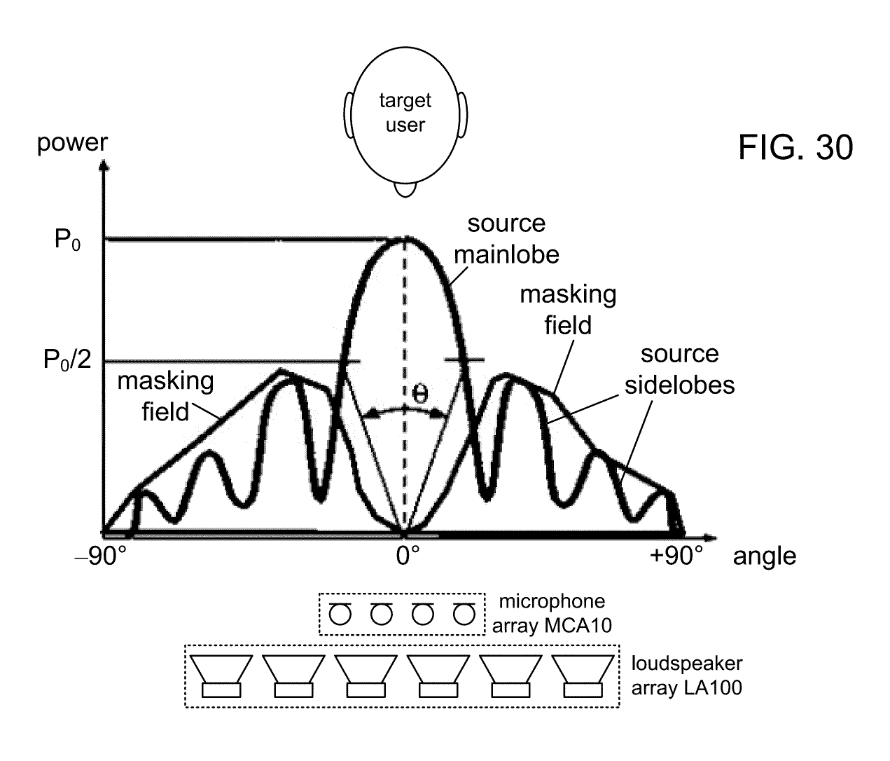

A method as described herein (e.g., method M300) may be combined with automatic speech recognition (ASR) for system control. The method may be configured, for example, to use an embedded speech recognition engine to create a privacy zone whenever an activation code is uttered (e.g., a particular phrase, such as “Qualcomm voice”). Such a method may also be configured to recognize words spoken after the activation code as command and/or payload parameters. Examples of such parameters include a command to initiate a telephone call to a particular person (e.g., “call Mom”). FIG. 30 shows a diagram of a typical use scenario for such an implementation of method M300 configured to receive signals from microphone array MCA10 and to drive loudspeaker array LA100.

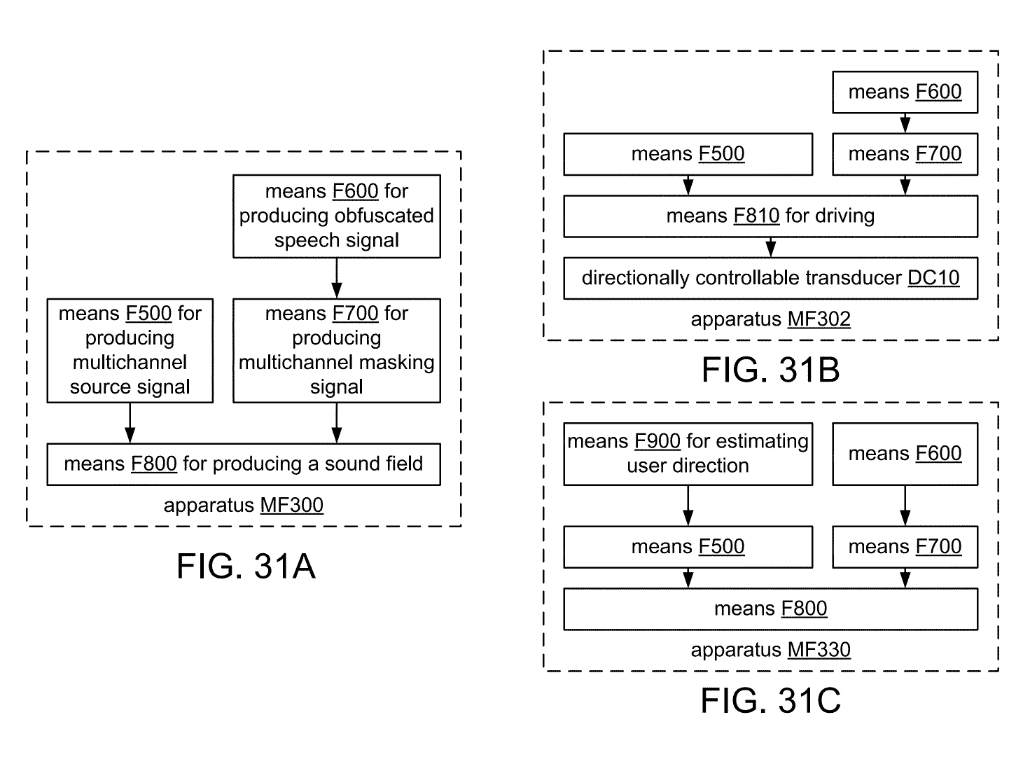

FIG. 31A shows a block diagram of an apparatus for signal processing MF300 according to a general configuration that includes means F500 for producing a multichannel source signal that is based on a speech signal (e.g., as described herein with reference to task T500). Apparatus MF300 also includes means F600 for producing an obfuscated speech signal that is based on the speech signal (e.g., as described herein with reference to task T600). Apparatus MF300 also includes means F700 for producing a multichannel masking signal that is based on the obfuscated speech signal (e.g., as described herein with reference to task T700). Apparatus MF100 also includes means F800 for producing a sound field that includes a source component based on the multichannel source signal and a masking component based on the multichannel masking signal (e.g., as described herein with reference to task T800).

FIG. 31B shows a block diagram of an implementation MF302 of apparatus MF300 that includes a directionally controllable transducer DC10 (e.g., a loudspeaker array) and an implementation F810 of means F800 that is for driving directionally controllable transducer DC10 to produce the sound field (e.g., as described herein with reference to task T800). FIG. 31C shows a block diagram of an implementation MF330 of apparatus MF300 that includes means F900 for estimating a direction of a user (e.g., as described herein with reference to task T900). Apparatus MF302 may also be realized as an implementation of apparatus MF330 (e.g., including an instance of means F900).

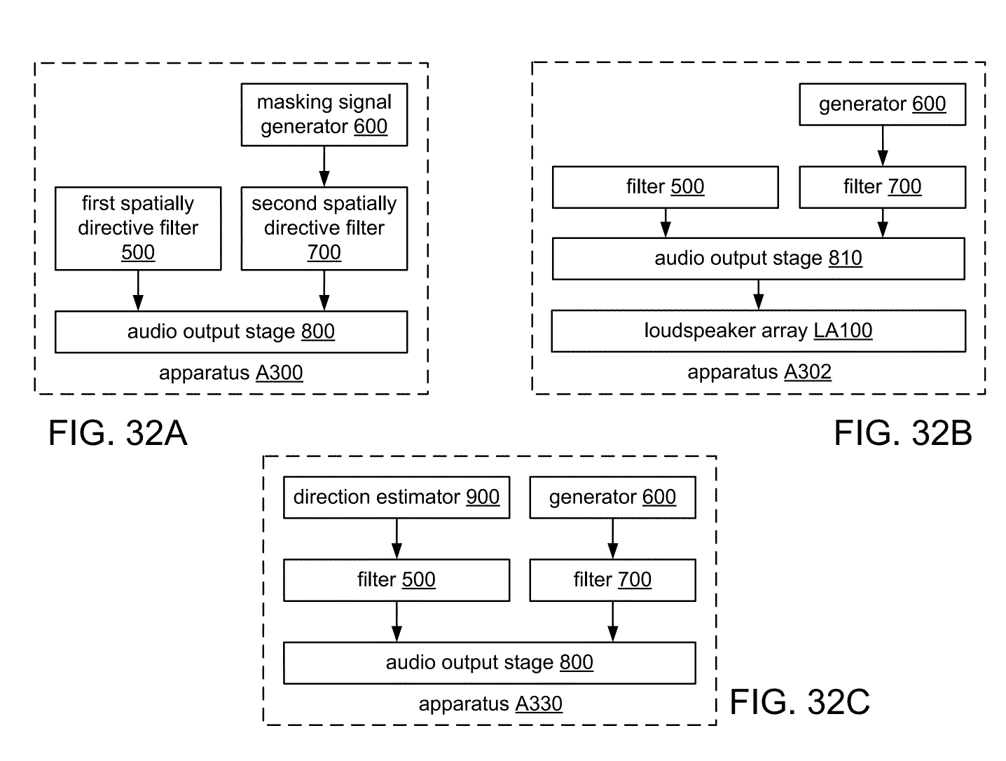

FIG. 32A shows a block diagram of an apparatus for signal processing A300 according to a general configuration that includes a first spatially selective filter 500, a masking signal generator 600, a second spatially selective filter 700, and an audio output stage 800. First spatially selective filter 500 is configured to produce a multichannel source signal that is based on a speech signal (e.g., as described herein with reference to task T500). Masking signal generator 600 is configured to produce an obfuscated speech signal that is based on the speech signal (e.g., as described herein with reference to task T600). Second spatially selective filter 700 is configured to produce a multichannel masking signal that is based on the obfuscated speech signal (e.g., as described herein with reference to task T700). Audio output stage 800 is configured to produce a set of driving signals that describe a sound field including a source component based on the multichannel source signal and a masking component based on the masking signal (e.g., as described herein with reference to task T800). Audio output stage 800 may also be implemented to perform other audio processing operations on the multichannel source signal, on the masking signal, and/or on the mixed channels to produce the driving signals.

FIG. 32B shows a block diagram of an implementation A302 of apparatus A300 that includes an instance of loudspeaker array LA100 arranged to produce the sound field in response to the driving signals as produced by an implementation 810 of audio output stage 800. FIG. 32C shows a block diagram of an implementation A330 of apparatus A300 that includes a direction estimator 900 configured to estimate a direction of a user relative to the apparatus (e.g., as described herein with reference to task T900). Apparatus A302 may also be realized as an implementation of apparatus A330 (e.g., including an instance of direction estimator 900).

Audio output stage 800 may be configured to mix the multichannel source and masking signals to produce a plurality of driving signals SD10-1 to SD10-N (e.g., as described herein with reference to tasks T800 and T810). Audio output stage 800 may be implemented to perform such mixing in the digital domain or in the analog domain. For example, audio output stage 800 may be configured to produce a driving signal for each loudspeaker channel by converting digital source and masking signals to analog, or by converting a digital mixed signal to analog. Audio output stage 800 may also be configured to amplify, apply a gain to, and/or control a gain of the source signal; to filter the source and/or masking signals; to provide impedance matching to the loudspeakers of the array; and/or to perform any other desired audio processing operation.

Each of the microphones for direction estimation as discussed herein (e.g., with reference to location and tracking of one or more users) may have a response that is omnidirectional, bidirectional, or unidirectional (e.g., cardioid). The various types of microphones that may be used include (without limitation) piezoelectric microphones, dynamic microphones, and electret microphones. It is expressly noted that the microphones may be implemented more generally as transducers sensitive to radiations or emissions other than sound. In one such example, the microphone array is implemented to include one or more ultrasonic transducers (e.g., transducers sensitive to acoustic frequencies greater than fifteen, twenty, twenty-five, thirty, forty, or fifty kilohertz or more).

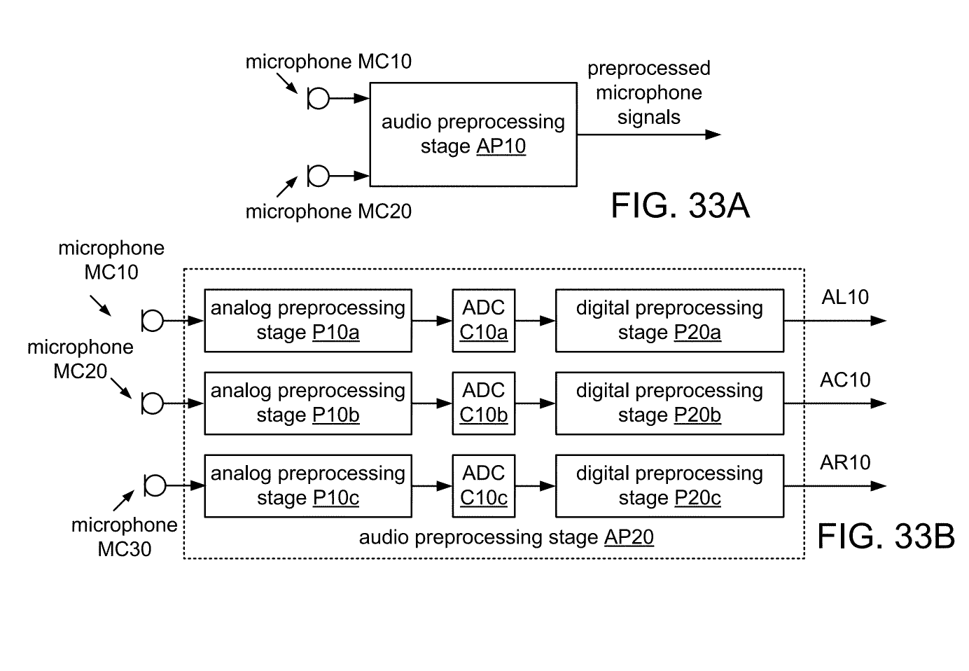

Each of apparatus A100, A102, A105, A150, A200, A300, A302, A330, MF100, MF102, MF150, MF200, MF300, MF302, and MF330 may be implemented as a combination of hardware (e.g., a processor) with software and/or with firmware. Such apparatus may also include an audio preprocessing stage AP10 as shown in FIG. 33A that performs one or more preprocessing operations on signals produced by each of the microphones MC10 and MC20 (e.g., of an implementation of microphone array MCA10) to produce preprocessed microphone signals (e.g., a corresponding one of a left microphone signal and a right microphone signal) for input to task T900 or direction estimator 900. Such preprocessing operations may include (without limitation) impedance matching, analog-to-digital conversion, gain control, and/or filtering in the analog and/or digital domains.

FIG. 33B shows a block diagram of a three-channel implementation AP20 of audio preprocessing stage AP10 that includes analog preprocessing stages P10a, P10b, and P10c. In one example, stages P10a, P10b, and P10c are each configured to perform a highpass filtering operation (e.g., with a cutoff frequency of 50, 100, or 200 Hz) on the corresponding microphone signal. Typically, stages P10a, P10b, and P10c will be configured to perform the same functions on each signal.

It may be desirable for audio preprocessing stage AP10 to produce each microphone signal as a digital signal, that is to say, as a sequence of samples. Audio preprocessing stage AP20, for example, includes analog-to-digital converters (ADCs) C10a, C10b, and C10c that are each arranged to sample the corresponding analog signal. Typical sampling rates for acoustic applications include 8 kHz, 12 kHz, 16 kHz, and other frequencies in the range of from about 8 to about 16 kHz, although sampling rates as high as about 44.1, 48, or 192 kHz may also be used. Typically, converters C10a, C10b, and C10c will be configured to sample each signal at the same rate.

In this example, audio preprocessing stage AP20 also includes digital preprocessing stages P20a, P20b, and P20c that are each configured to perform one or more preprocessing operations (e.g., spectral shaping) on the corresponding digitized channel to produce a corresponding one of a left microphone signal AL10, a center microphone signal AC10, and a right microphone signal AR10 for input to task T900 or direction estimator 900. Typically, stages P20a, P20b, and P20c will be configured to perform the same functions on each signal. It is also noted that preprocessing stage AP10 may be configured to produce a different version of a signal from at least one of the microphones (e.g., at a different sampling rate and/or with different spectral shaping) for content use, such as to provide a near-end speech signal in a voice communication (e.g., a telephone call). Although FIGS. 33A and 33B show two-channel and three-channel implementations, respectively, it will be understood that the same principles may be extended to an arbitrary number of microphones.

Loudspeaker array LA100 may include cone-type and/or rectangular loudspeakers. The spacings between adjacent loudspeakers may be uniform or nonuniform, and the array may be linear or nonlinear. As noted above, techniques for generating the multichannel signals for driving the array may include pairwise BFNF and MVDR.

When beamforming techniques are used to produce spatial patterns for broadband signals, selection of the transducer array geometry involves a trade-off between low and high frequencies. To enhance the direct handling of low frequencies by the beamformer, a larger loudspeaker spacing is preferred. At the same time, if the spacing between loudspeakers is too large, the ability of the array to reproduce the desired effects at high frequencies will be limited by a lower aliasing threshold. To avoid spatial aliasing, the wavelength of the highest frequency component to be reproduced by the array should be greater than twice the distance between adjacent loudspeakers.

As consumer devices become smaller and smaller, the form factor may constrain the placement of loudspeaker arrays. For example, it may be desirable for a laptop, netbook, or tablet computer or a high-definition video display to have a built-in loudspeaker array. Due to the size constraints, the loudspeakers may be small and unable to reproduce a desired bass region. Alternatively, the loudspeakers may be large enough to reproduce the bass region but spaced too closely to support beamforming or other acoustic imaging. Thus it may be desirable to provide the processing to produce a bass signal in a closely spaced loudspeaker array in which beamforming is employed.

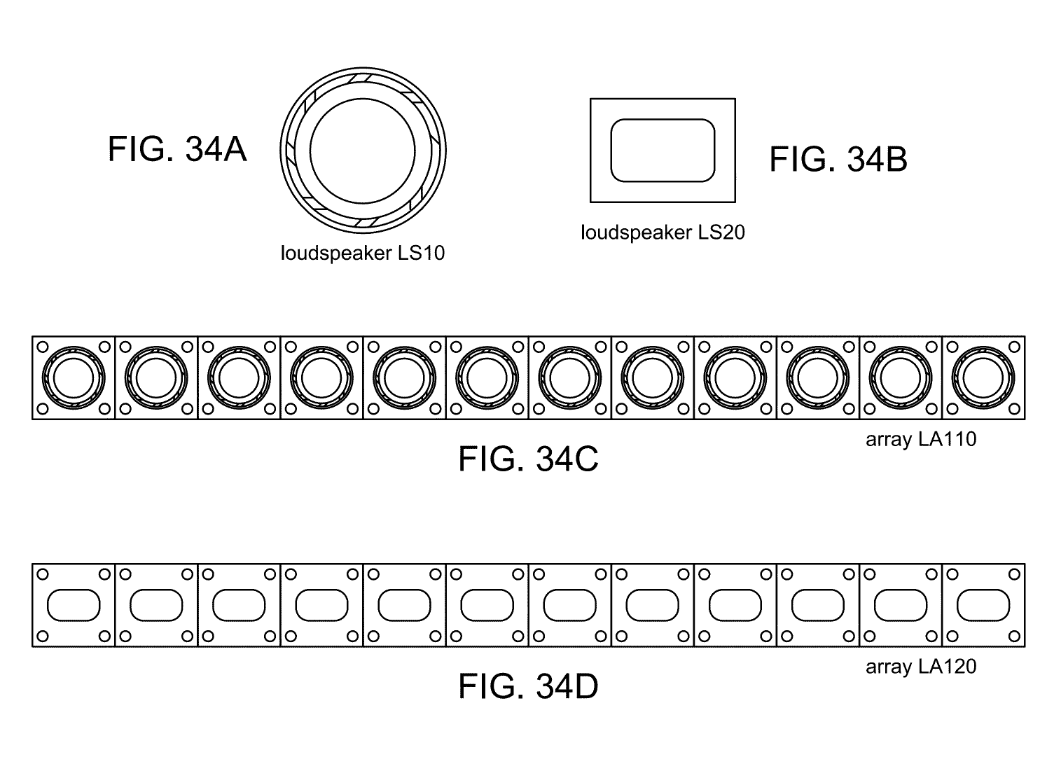

FIG. 34A shows an example LS10 of a cone-type loudspeaker, and FIG. 34B shows an example LS20 of a rectangular loudspeaker (e.g., RA11×15×3.5, NXP Semiconductors, Eindhoven, NL). FIG. 34C shows an implementation LA110 of array LA100 as an array of twelve loudspeakers as shown in FIG. 34A, and FIG. 34D shows an implementation LA120 of array LA100 as an array of twelve loudspeakers as shown in FIG. 34B. In the examples of FIGS. 34C and 34D, the inter-loudspeaker distance is 2.6 cm, and the length of the array (31.2 cm) is approximately equal to the width of a typical laptop computer.

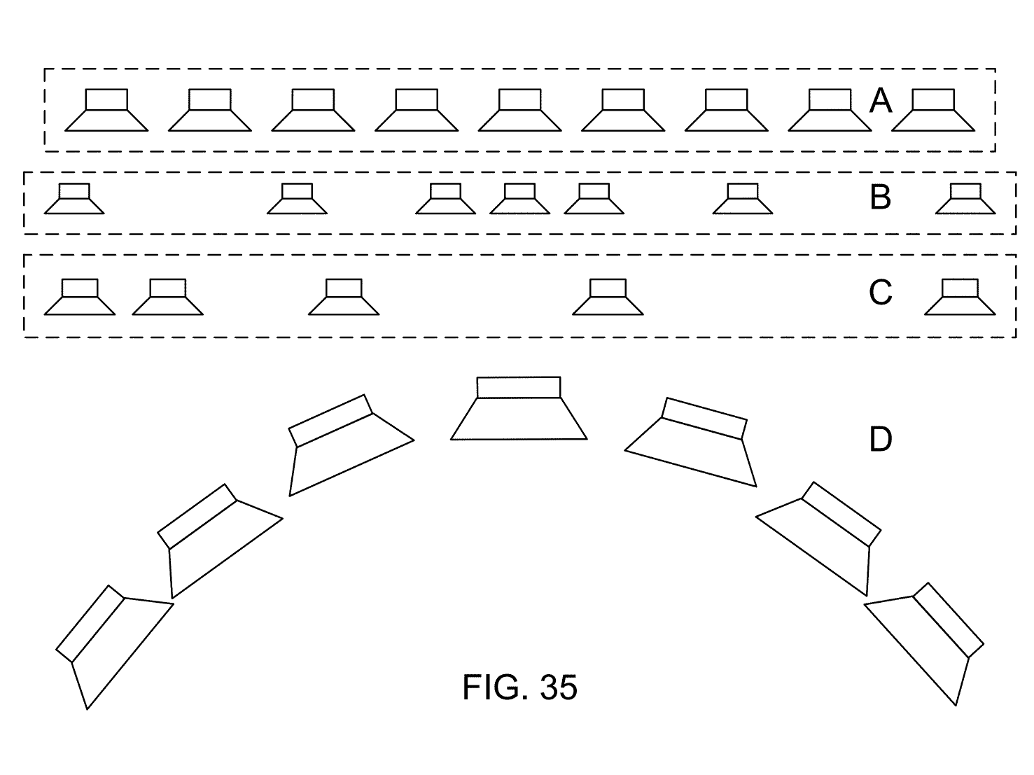

It is expressly noted that the principles described herein are not limited to use with a uniform linear array of loudspeakers (e.g., as shown in FIG. 35A). For example, directional masking may also be used with a linear array having a nonuniform spacing between adjacent loudspeakers. FIG. 35B shows one example of such an implementation of array LA100 having symmetrical octave spacing between the loudspeakers, and FIG. 35C shows another example of such an implementation having asymmetrical octave spacing. Additionally, such principles are not limited to use with linear arrays and may also be used with implementations of array LA100 whose elements are arranged along a simple curve, whether with uniform spacing (e.g., as shown in FIG. 35D) or with nonuniform (e.g., octave) spacing. The same principles stated herein also apply separably to each array in applications having multiple arrays along the same or different (e.g., orthogonal) straight or curved axes.

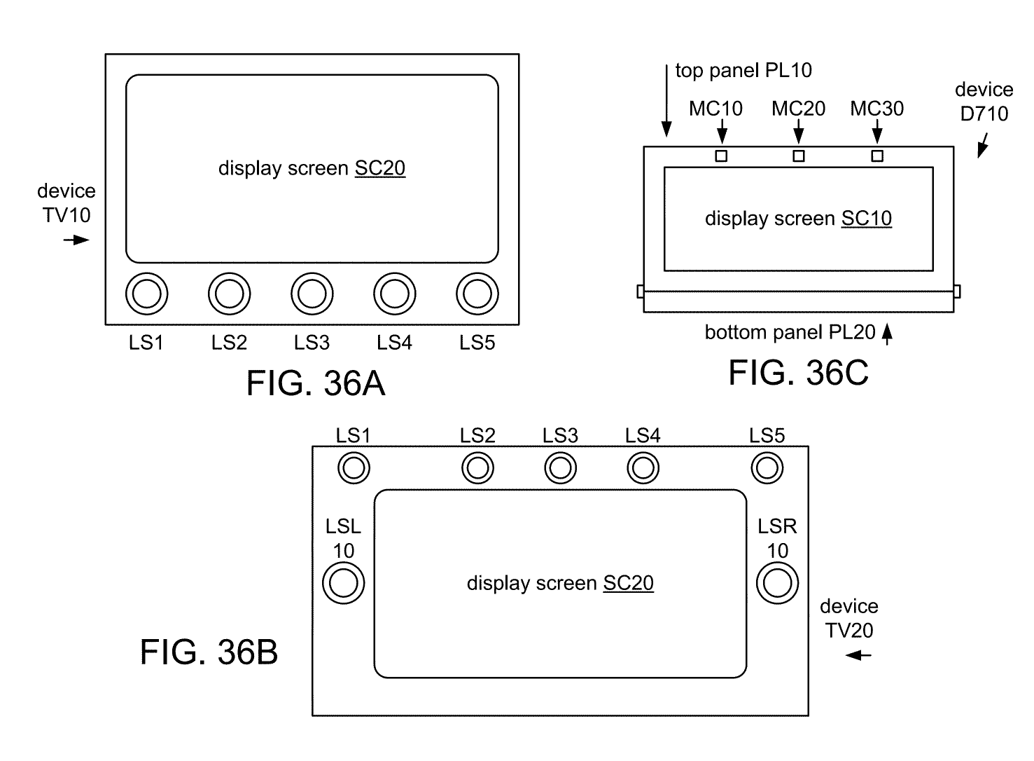

FIG. 36A shows an implementation of array LA100 to be driven by an implementation of apparatus A100. In this example, the array is a linear arrangement of five uniformly spaced loudspeakers LS1 to LS5 that are arranged below a display screen SC20 in a display device TV10 (e.g., a television or computer monitor). FIG. 36B shows another implementation of array LA100 in such a display device TV20 to be driven by an implementation of apparatus A100. In this case, loudspeakers LS1 to LS5 are arranged linearly with non-uniform spacing, and the array also includes larger loudspeakers LSL10 and LSR10 on either side of display screen SC20. A laptop computer D710 as shown in FIG. 36C may also be configured to include such an array (e.g., in behind and/or beside a keyboard in bottom panel PL20 and/or in the margin of display screen SC10 in top panel PL10). Device D710 also includes three microphones MC10, MC20, and MC30 that may be used for direction estimation as described herein. Devices TV10 and TV20 may also be implemented to include such a microphone array (e.g., arranged horizontally among the loudspeakers and/or in a different margin of the bezel). Loudspeaker array LA100 may also be enclosed in one or more separate cabinets or installed in the interior of a vehicle such as an automobile.

In the example of FIG. 6, it may be expected that the main beam directed at zero degrees in the frontal direction will also be audible in the back direction (e.g., at 180 degrees). Such a phenomenon, which is common in the context of a linear array of loudspeakers or microphones, is also referred to as a “cone of confusion” problem. It may be desirable to extend direction control into a front-back direction and/or into an up-down direction.

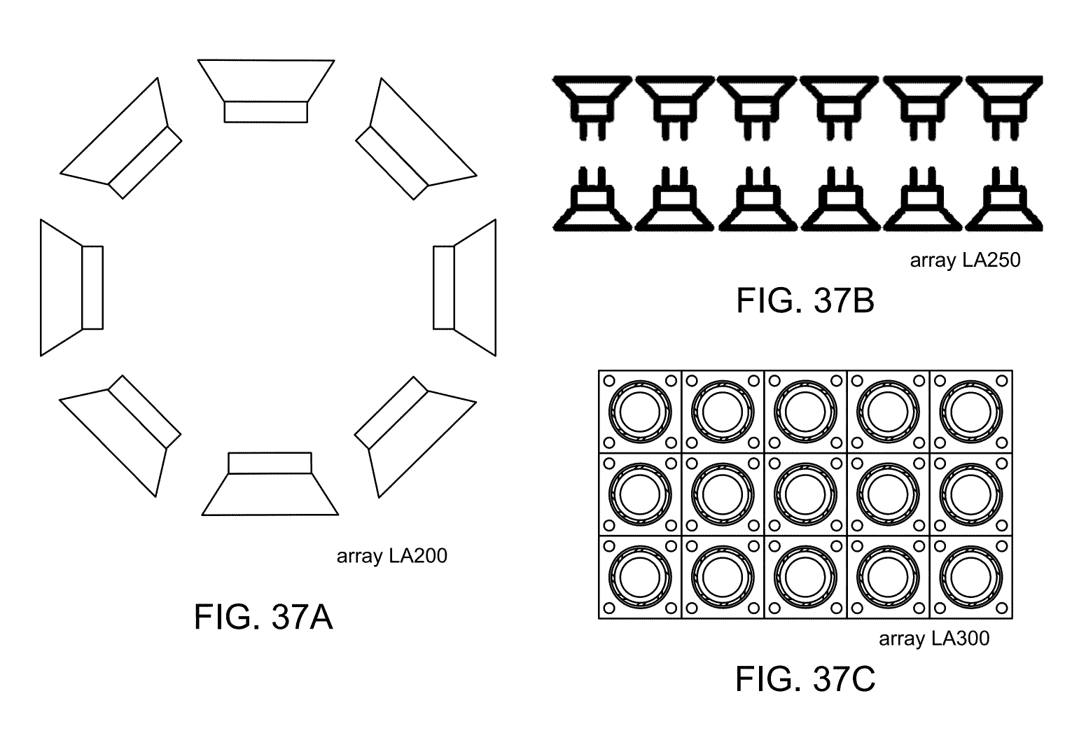

Although particular examples of directional masking in a range of 180 degrees are shown, the principles described herein may be extended to provide directional masking across any desired angular range in a plane (e.g., a two-dimensional range). Such extension may include the addition of appropriately placed loudspeakers to the array. For example, FIG. 6 shows an example of directional masking in a left-right direction. It may be desirable to add loudspeakers to array LA100 as shown in FIG. 6 to provide a front-back array for masking in a front-back direction as well. FIGS. 37A and 37B show top views of two examples LA200, LA250 of such an expanded implementation of array LA100.

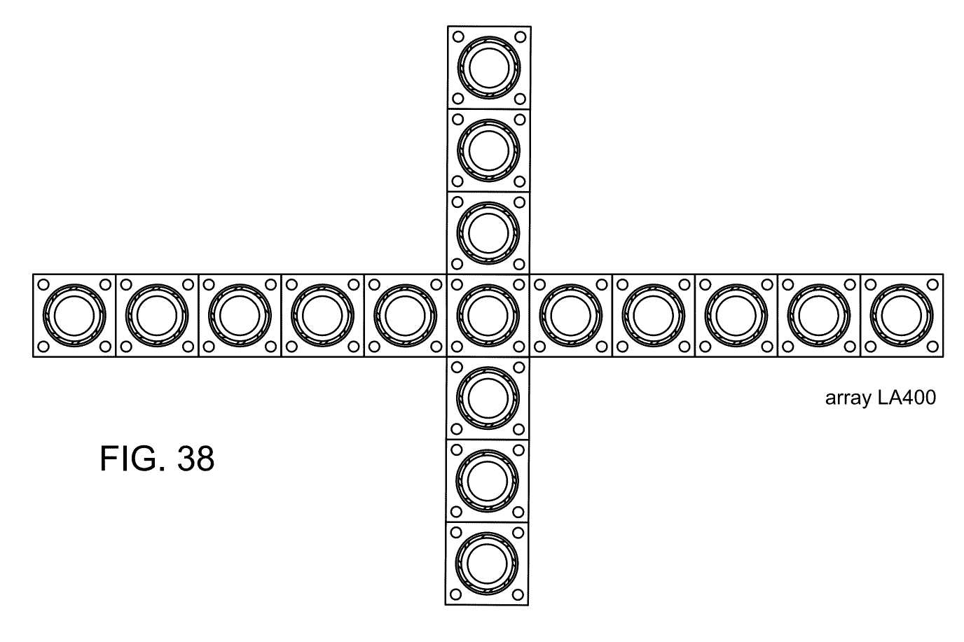

Such principles may also be extended to provide directional masking across any desired angular range in space (e.g., in three dimensions). FIGS. 37C and 38 show front views of two implementations LA300, LA400 of array LA100 that may be used to provide directional masking in both left-right and up-down directions. Further examples include spherical or other three-dimensional arrays for directional masking in a range up to 360 degrees (e.g., for a complete privacy zone of 4×pi radians).

A psychoacoustic phenomenon exists that listening to higher harmonics of a signal may create a perceptual illusion of hearing the missing fundamentals. Thus, one way to achieve a sensation of bass components from small loudspeakers is to generate higher harmonics from the bass components and play back the harmonics instead of the actual bass components. Descriptions of algorithms for substituting higher harmonics to achieve a psychoacoustic sensation of bass without an actual low-frequency signal presence (also called “psychoacoustic bass enhancement” or PBE) may be found, for example, in U.S. Pat. No. 5,930,373 (Shashoua et al., issued Jul. 27, 1999) and U.S. Publ. Pat. Appls. Nos. 2006/0159283 A1 (Mathew et al., published Jul. 20, 2006), 2009/0147963 A1 (Smith, published Jun. 11, 2009), and 2010/0158272 A1 (Vickers, published Jun. 24, 2010). Such enhancement may be particularly useful for reproducing low-frequency sounds with devices that have form factors which restrict the integrated loudspeaker or loudspeakers to be physically small. For example, task T800 may be implemented to perform PBE to produce the driving signals that drive the array of loudspeakers to produce the combined sound field.

It may be desirable to apply PBE not only to reduce the effect of low-frequency reproducibility limits, but also to reduce the effect of directivity loss at low frequencies. For example, it may be desirable to combine PBE with spatially directive filtering (e.g., beamforming) to create the perception of low-frequency content in a range that is steerable by a beamformer. In one example, any of the implementations of task T500 as described herein is modified to perform PBE on the source signal and to produce the multichannel source signal from the PBE-processed source signal. In the same example or in an alternative example, any of the implementations of task T700 as described herein is modified to perform PBE on the masking signal and to produce the multichannel masking signal from the PBE-processed masking signal.

The use of a loudspeaker array to produce directional beams from an enhanced signal results in an output that has a much lower perceived frequency range than an output from the audio signal without such enhancement. Additionally, it becomes possible to use a more relaxed beamformer design to steer the enhanced signal, which may support a reduction of artifacts and/or computational complexity and allow more efficient steering of bass components with arrays of small loudspeakers. At the same time, such a system can protect small loudspeakers from damage by low-frequency signals (e.g., rumble). Additional description of such enhancement techniques, which may be combined with directional masking as described herein, may be found in, e.g., U.S. patent application Ser. No. 13/190,464, entitled “SYSTEMS, METHODS, AND APPARATUS FOR ENHANCED ACOUSTIC IMAGING” (filed Jul. 25, 2011).

The methods and apparatus disclosed herein may be applied generally in any transceiving and/or audio sensing application, including mobile or otherwise portable instances of such applications and/or sensing of signal components from far-field sources. For example, the range of configurations disclosed herein includes communications devices that reside in a wireless telephony communication system configured to employ a code-division multiple-access (CDMA) over-the-air interface. Nevertheless, it would be understood by those skilled in the art that a method and apparatus having features as described herein may reside in any of the various communication systems employing a wide range of technologies known to those of skill in the art, such as systems employing Voice over IP (VoIP) over wired and/or wireless (e.g., CDMA, TDMA, FDMA, and/or TD-SCDMA) transmission channels.

It is expressly contemplated and hereby disclosed that communications devices disclosed herein may be adapted for use in networks that are packet-switched (for example, wired and/or wireless networks arranged to carry audio transmissions according to protocols such as VoIP) and/or circuit-switched. It is also expressly contemplated and hereby disclosed that communications devices disclosed herein may be adapted for use in narrowband coding systems (e.g., systems that encode an audio frequency range of about four or five kilohertz) and/or for use in wideband coding systems (e.g., systems that encode audio frequencies greater than five kilohertz), including whole-band wideband coding systems and split-band wideband coding systems.

The foregoing presentation of the described configurations is provided to enable any person skilled in the art to make or use the methods and other structures disclosed herein. The flowcharts, block diagrams, and other structures shown and described herein are examples only, and other variants of these structures are also within the scope of the disclosure. Various modifications to these configurations are possible, and the generic principles presented herein may be applied to other configurations as well. Thus, the present disclosure is not intended to be limited to the configurations shown above but rather is to be accorded the widest scope consistent with the principles and novel features disclosed in any fashion herein, including in the attached claims as filed, which form a part of the original disclosure.

Those of skill in the art will understand that information and signals may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

Important design requirements for implementation of a configuration as disclosed herein may include minimizing processing delay and/or computational complexity (typically measured in millions of instructions per second or MIPS), especially for computation-intensive applications, such as playback of compressed audio or audiovisual information (e.g., a file or stream encoded according to a compression format, such as one of the examples identified herein) or applications for wideband communications (e.g., voice communications at sampling rates higher than eight kilohertz, such as 12, 16, 32, 44.1, 48, or 192 kHz).

Goals of a multi-microphone processing system may include achieving ten to twelve dB in overall noise reduction, preserving voice level and color during movement of a desired speaker, obtaining a perception that the noise has been moved into the background instead of an aggressive noise removal, dereverberation of speech, and/or enabling the option of post-processing for more aggressive noise reduction.

An apparatus as disclosed herein (e.g., any among apparatus A100, A102, A105, A150, A200, A300, A302, A330, MF100, MF102, MF150, MF200, MF300, MF302, and MF330) may be implemented in any combination of hardware with software, and/or with firmware, that is deemed suitable for the intended application. For example, the elements of such an apparatus may be fabricated as electronic and/or optical devices residing, for example, on the same chip or among two or more chips in a chipset. One example of such a device is a fixed or programmable array of logic elements, such as transistors or logic gates, and any of these elements may be implemented as one or more such arrays. Any two or more, or even all, of the elements of the apparatus may be implemented within the same array or arrays. Such an array or arrays may be implemented within one or more chips (for example, within a chipset including two or more chips).

One or more elements of the various implementations of the apparatus disclosed herein may also be implemented in whole or in part as one or more sets of instructions arranged to execute on one or more fixed or programmable arrays of logic elements, such as microprocessors, embedded processors, IP cores, digital signal processors, FPGAs (field-programmable gate arrays), ASSPs (application-specific standard products), and ASICs (application-specific integrated circuits). Any of the various elements of an implementation of an apparatus as disclosed herein may also be embodied as one or more computers (e.g., machines including one or more arrays programmed to execute one or more sets or sequences of instructions, also called “processors”), and any two or more, or even all, of these elements may be implemented within the same such computer or computers.

A processor or other means for processing as disclosed herein may be fabricated as one or more electronic and/or optical devices residing, for example, on the same chip or among two or more chips in a chipset. One example of such a device is a fixed or programmable array of logic elements, such as transistors or logic gates, and any of these elements may be implemented as one or more such arrays. Such an array or arrays may be implemented within one or more chips (for example, within a chipset including two or more chips). Examples of such arrays include fixed or programmable arrays of logic elements, such as microprocessors, embedded processors, IP cores, DSPs, FPGAs, ASSPs, and ASICs. A processor or other means for processing as disclosed herein may also be embodied as one or more computers (e.g., machines including one or more arrays programmed to execute one or more sets or sequences of instructions) or other processors. It is possible for a processor as described herein to be used to perform tasks or execute other sets of instructions that are not directly related to a directional sound masking procedure as described herein, such as a task relating to another operation of a device or system in which the processor is embedded (e.g., an audio sensing device). It is also possible for part of a method as disclosed herein to be performed by a processor of the audio sensing device and for another part of the method to be performed under the control of one or more other processors.

Those of skill will appreciate that the various illustrative modules, logical blocks, circuits, and tests and other operations described in connection with the configurations disclosed herein may be implemented as electronic hardware, computer software, or combinations of both. Such modules, logical blocks, circuits, and operations may be implemented or performed with a general purpose processor, a digital signal processor (DSP), an ASIC or ASSP, an FPGA or other programmable logic device, discrete gate or transistor logic, discrete hardware components, or any combination thereof designed to produce the configuration as disclosed herein. For example, such a configuration may be implemented at least in part as a hard-wired circuit, as a circuit configuration fabricated into an application-specific integrated circuit, or as a firmware program loaded into non-volatile storage or a software program loaded from or into a data storage medium as machine-readable code, such code being instructions executable by an array of logic elements such as a general purpose processor or other digital signal processing unit. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. A software module may reside in a non-transitory storage medium such as RAM (random-access memory), ROM (read-only memory), nonvolatile RAM (NVRAM) such as flash RAM, erasable programmable ROM (EPROM), electrically erasable programmable ROM (EEPROM), registers, hard disk, a removable disk, or a CD-ROM; or in any other form of storage medium known in the art. An illustrative storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

It is noted that the various methods disclosed herein (e.g., any among methods M100, M102, M150, M200, M300, M310, M320, M330, and other methods disclosed by way of description of the operation of the various apparatus described herein) may be performed by an array of logic elements such as a processor, and that the various elements of an apparatus as described herein may be implemented as modules designed to execute on such an array. As used herein, the term “module” or “sub-module” can refer to any method, apparatus, device, unit or computer-readable data storage medium that includes computer instructions (e.g., logical expressions) in software, hardware or firmware form. It is to be understood that multiple modules or systems can be combined into one module or system and one module or system can be separated into multiple modules or systems to perform the same functions. When implemented in software or other computer-executable instructions, the elements of a process are essentially the code segments to perform the related tasks, such as with routines, programs, objects, components, data structures, and the like. The term “software” should be understood to include source code, assembly language code, machine code, binary code, firmware, macrocode, microcode, any one or more sets or sequences of instructions executable by an array of logic elements, and any combination of such examples. The program or code segments can be stored in a processor-readable storage medium or transmitted by a computer data signal embodied in a carrier wave over a transmission medium or communication link.

The implementations of methods, schemes, and techniques disclosed herein may also be tangibly embodied (for example, in tangible, computer-readable features of one or more computer-readable storage media as listed herein) as one or more sets of instructions readable and/or executable by a machine including an array of logic elements (e.g., a processor, microprocessor, microcontroller, or other finite state machine). The term “computer-readable medium” may include any medium that can store or transfer information, including volatile, nonvolatile, removable and non-removable media. Examples of a computer-readable medium include an electronic circuit, a semiconductor memory device, a ROM, a flash memory, an erasable ROM (EROM), a floppy diskette or other magnetic storage, a CD-ROM/DVD or other optical storage, a hard disk, a fiber optic medium, a radio frequency (RF) link, or any other medium which can be used to store the desired information and which can be accessed. The computer data signal may include any signal that can propagate over a transmission medium such as electronic network channels, optical fibers, air, electromagnetic, RF links, etc. The code segments may be downloaded via computer networks such as the Internet or an intranet. In any case, the scope of the present disclosure should not be construed as limited by such embodiments.

Each of the tasks of the methods described herein may be embodied directly in hardware, in a software module executed by a processor, or in a combination of the two. In a typical application of an implementation of a method as disclosed herein, an array of logic elements (e.g., logic gates) is configured to perform one, more than one, or even all of the various tasks of the method. One or more (possibly all) of the tasks may also be implemented as code (e.g., one or more sets of instructions), embodied in a computer program product (e.g., one or more data storage media such as disks, flash or other nonvolatile memory cards, semiconductor memory chips, etc.), that is readable and/or executable by a machine (e.g., a computer) including an array of logic elements (e.g., a processor, microprocessor, microcontroller, or other finite state machine). The tasks of an implementation of a method as disclosed herein may also be performed by more than one such array or machine. In these or other implementations, the tasks may be performed within a device for wireless communications such as a cellular telephone or other device having such communications capability. Such a device may be configured to communicate with circuit-switched and/or packet-switched networks (e.g., using one or more protocols such as VoIP). For example, such a device may include RF circuitry configured to receive and/or transmit encoded frames.

s expressly disclosed that the various methods disclosed herein may be performed by a portable communications device such as a handset, headset, or portable digital assistant (PDA), and that the various apparatus described herein may be included within such a device. A typical real-time (e.g., online) application is a telephone conversation conducted using such a mobile device.

In one or more exemplary embodiments, the operations described herein may be implemented in hardware, software, firmware, or any combination thereof. If implemented in software, such operations may be stored on or transmitted over a computer-readable medium as one or more instructions or code. The term “computer-readable media” includes both computer-readable storage media and communication (e.g., transmission) media. By way of example, and not limitation, computer-readable storage media can comprise an array of storage elements, such as semiconductor memory (which may include without limitation dynamic or static RAM, ROM, EEPROM, and/or flash RAM), or ferroelectric, magnetoresistive, ovonic, polymeric, or phase-change memory; CD-ROM or other optical disk storage; and/or magnetic disk storage or other magnetic storage devices. Such storage media may store information in the form of instructions or data structures that can be accessed by a computer. Communication media can comprise any medium that can be used to carry desired program code in the form of instructions or data structures and that can be accessed by a computer, including any medium that facilitates transfer of a computer program from one place to another. Also, any connection is properly termed a computer-readable medium. For example, if the software is transmitted from a website, server, or other remote source using a coaxial cable, fiber optic cable, twisted pair, digital subscriber line (DSL), or wireless technology such as infrared, radio, and/or microwave, then the coaxial cable, fiber optic cable, twisted pair, DSL, or wireless technology such as infrared, radio, and/or microwave are included in the definition of medium. Disk and disc, as used herein, includes compact disc (CD), laser disc, optical disc, digital versatile disc (DVD), floppy disk and Blu-ray Disc™ (Blu-Ray Disc Association, Universal City, Calif.), where disks usually reproduce data magnetically, while discs reproduce data optically with lasers. Combinations of the above should also be included within the scope of computer-readable media.

An acoustic signal processing apparatus as described herein (e.g., any among apparatus A100, A102, A105, A150, A200, A300, A302, A330, MF100, MF102, MF150, MF200, MF300, MF302, and MF330) may be incorporated into an electronic device that accepts speech input in order to control certain operations, or may otherwise benefit from separation of desired noises from background noises, such as communications devices. Many applications may benefit from enhancing or separating clear desired sound from background sounds originating from multiple directions. Such applications may include human-machine interfaces in electronic or computing devices which incorporate capabilities such as voice recognition and detection, speech enhancement and separation, voice-activated control, and the like. It may be desirable to implement such an acoustic signal processing apparatus to be suitable in devices that only provide limited processing capabilities.

The elements of the various implementations of the modules, elements, and devices described herein may be fabricated as electronic and/or optical devices residing, for example, on the same chip or among two or more chips in a chipset. One example of such a device is a fixed or programmable array of logic elements, such as transistors or gates. One or more elements of the various implementations of the apparatus described herein may also be implemented in whole or in part as one or more sets of instructions arranged to execute on one or more fixed or programmable arrays of logic elements such as microprocessors, embedded processors, IP cores, digital signal processors, FPGAs, ASSPs, and ASICs.

It is possible for one or more elements of an implementation of an apparatus as described herein to be used to perform tasks or execute other sets of instructions that are not directly related to an operation of the apparatus, such as a task relating to another operation of a device or system in which the apparatus is embedded. It is also possible for one or more elements of an implementation of such an apparatus to have structure in common (e.g., a processor used to execute portions of code corresponding to different elements at different times, a set of instructions executed to perform tasks corresponding to different elements at different times, or an arrangement of electronic and/or optical devices performing operations for different elements at different times).

What is claimed is:

1. A method of signal processing, said method comprising:
producing a multichannel source signal that is based on a speech signal;
producing an obfuscated speech signal that is based on the speech signal;
producing a multichannel masking signal that is based on the obfuscated speech signal; and
driving a directionally controllable transducer, in response to the multichannel source signal and the multichannel masking signal, to produce a sound field comprising (A) a source component that is based on the multichannel source signal and (B) a masking component that is based on the multichannel masking signal.

2. The method according to claim 1, wherein said producing an obfuscated speech signal comprises, for each of a plurality of frames of the speech signal and for each of a plurality of different frequencies:
calculating an envelope of the frame at the frequency;
filtering the calculated envelope to obtain a filtered envelope; and
applying the filtered envelope to a carrier signal at the frequency to obtain a modulated carrier signal, and
wherein said producing an obfuscated speech signal comprises, for each of said plurality of frames of the speech signal, producing a corresponding frame of the obfuscated speech signal by combining the corresponding plurality of modulated carrier signals.

3. The method according to claim 2, wherein, for each of said plurality of frames of the speech signal and for each of said plurality of different frequencies, said calculating the envelope of the frame at the frequency comprises applying, to the frame, a narrowband filter at the frequency.

4. The method according to claim 2, wherein, for each of said plurality of frames of the speech signal and for each of said plurality of different frequencies, said calculated envelope is a complex envelope.

5. The method according to claim 2, wherein, for each of said plurality of frames of the speech signal and for each of said plurality of different frequencies, said filtering the calculated envelope comprises applying a lowpass filter to the calculated envelope to obtain the filtered envelope.

6. The method according to claim 2, wherein an order in time of said corresponding frames of the obfuscated speech signal within the obfuscated speech signal is the same as an order in time of said plurality of frames of the speech signal within the speech signal.

7. The method according to claim 2, wherein each of said plurality of different frequencies is a harmonic of a pitch frequency of the speech signal.

8. The method according to claim 2, wherein said method comprises interpolating between estimates of a pitch frequency of the speech signal to obtain a pitch track of the speech signal, and wherein said plurality of different frequencies is based on said obtained pitch track.

9. The method according to claim 8, wherein said speech signal is based on an encoded signal that includes a plurality of pitch lag values, and wherein said pitch track is based on said plurality of pitch lag values.

10. The method according to claim 1, wherein energy of the source component is concentrated along a source direction relative to an axis of the transducer, and
wherein energy of the masking component is concentrated along a leakage direction, relative to said axis, that is different than the source direction.

11. The method according to claim 10, wherein said multichannel masking signal is based on an estimated intensity of the source component in the leakage direction.

12. The method according to claim 11, wherein said producing the multichannel source signal comprises applying a spatially directive filter to the speech signal to produce the multichannel source signal, and
wherein said estimated intensity of the source component in the leakage direction is based on coefficient values of the spatially directive filter.

13. The method according to claim 1, wherein said method comprises estimating a direction of a user relative to the directionally controllable transducer, and wherein said source direction is based on said estimated user direction.

14. The method according to claim 1, wherein the masking component includes a null in the source direction.

15. An apparatus for signal processing, said apparatus comprising:
means for producing a multichannel source signal that is based on a speech signal;
means for producing an obfuscated speech signal that is based on the speech signal;
means for producing a multichannel masking signal that is based on the obfuscated speech signal; and
means for driving a directionally controllable transducer, in response to the multichannel source signal and the multichannel masking signal, to produce a sound field comprising (A) a source component that is based on the multichannel source signal and (B) a masking component that is based on the multichannel masking signal.

16. The apparatus according to claim 15, wherein said means for producing an obfuscated speech signal comprises:
means for calculating, for each of a plurality of frames of the speech signal and for each of a plurality of different frequencies, an envelope of the frame at the frequency;
means for filtering, for each of the plurality of frames of the speech signal, each of said calculated envelopes to obtain a corresponding filtered envelope of a plurality of filtered envelopes;
means for applying, for each of the plurality of frames of the speech signal, each of the plurality of filtered envelopes to a carrier signal at the corresponding frequency to obtain a corresponding modulated carrier signal of a plurality of modulated carrier signals; and
means for producing, for each of said plurality of frames of the speech signal, a corresponding frame of the obfuscated speech signal by combining the corresponding plurality of modulated carrier signals.

17. The apparatus according to claim 16, wherein said means for calculating, for each of said plurality of frames of the speech signal and for each of said plurality of different frequencies, the envelope of the frame at the frequency comprises means for applying, to each of said plurality of frames of the speech signal and for each of said plurality of different frequencies, a narrowband filter at the frequency.

18. The apparatus according to claim 16, wherein, for each of said plurality of frames of the speech signal and for each of said plurality of different frequencies, said calculated envelope is a complex envelope.

19. The apparatus according to claim 16, wherein said means for filtering, for each of said plurality of frames of the speech signal, each of said calculated envelopes comprises means for applying, for each of said plurality of frames of the speech signal, a lowpass filter to each of said calculated envelopes to obtain the corresponding filtered envelope.

20. The apparatus according to claim 16, wherein an order in time of said corresponding frames of the obfuscated speech signal within the obfuscated speech signal is the same as an order in time of said plurality of frames of the speech signal within the speech signal.

21. The apparatus according to claim 16, wherein each of said plurality of different frequencies is a harmonic of a pitch frequency of the speech signal.

22. The apparatus according to claim 16, wherein said apparatus comprises means for interpolating between estimates of a pitch frequency of the speech signal to obtain a pitch track of the speech signal, and wherein said plurality of different frequencies is based on said obtained pitch track.

23. The apparatus according to claim 22, wherein said speech signal is based on an encoded signal that includes a plurality of pitch lag values, and wherein said pitch track is based on said plurality of pitch lag values.

24. The apparatus according to claim 15, wherein energy of the source component is concentrated along a source direction relative to an axis of the transducer, and
wherein energy of the masking component is concentrated along a leakage direction, relative to said axis, that is different than the source direction.

25. The apparatus according to claim 24, wherein said multichannel masking signal is based on an estimated intensity of the source component in the leakage direction.

26. The apparatus according to claim 25, wherein said means for producing the multichannel source signal comprises means for applying a spatially directive filter to the speech signal to produce the multichannel source signal, and
wherein said estimated intensity of the source component in the leakage direction is based on coefficient values of the spatially directive filter.

27. The apparatus according to claim 15, wherein said apparatus comprises means for estimating a direction of a user relative to the directionally controllable transducer, and
wherein said source direction is based on said estimated user direction.

28. The apparatus according to claim 15, wherein the masking component includes a null in the source direction.

29. An apparatus for signal processing, said apparatus comprising:
a first spatially directive filter configured to produce a multichannel source signal that is based on a speech signal;
a masking signal generator configured to produce an obfuscated speech signal that is based on the speech signal;
a second spatially directive filter configured to produce a multichannel masking signal that is based on the obfuscated speech signal; and
an audio output stage configured to drive a directionally controllable transducer, in response to the multichannel source signal and the multichannel masking signal, to produce a sound field comprising (A) a source component that is based on the multichannel source signal and (B) a masking component that is based on the multichannel masking signal.

30. The apparatus according to claim 29, wherein said masking signal generator comprises:
an envelope calculator configured to calculate, for each of a plurality of frames of the speech signal and for each of a plurality of different frequencies, an envelope of the frame at the frequency;
a filter bank arranged to filter, for each of the plurality of frames of the speech signal, each of said calculated envelopes to obtain a corresponding filtered envelope of a plurality of filtered envelopes;
a modulator configured to apply, for each of the plurality of frames of the speech signal, each of the plurality of filtered envelopes to a carrier signal at the corresponding frequency to obtain a corresponding modulated carrier signal of a plurality of modulated carrier signals; and
a combiner configured to produce, for each of the plurality of frames of the speech signal, a corresponding frame of the obfuscated speech signal by combining the corresponding plurality of modulated carrier signals.

31. The apparatus according to claim 30, wherein said envelope calculator is configured to apply, to each of said plurality of frames of the speech signal and for each of said plurality of different frequencies, a narrowband filter at the frequency.

32. The apparatus according to claim 30, wherein, for each of said plurality of frames of the speech signal and for each of said plurality of different frequencies, said calculated envelope is a complex envelope.

33. The apparatus according to claim 30, wherein said filter bank is configured to apply, for each of said plurality of frames of the speech signal, a lowpass filter to each of said calculated envelopes to obtain the corresponding filtered envelope.

34. The apparatus according to claim 30, wherein an order in time of said corresponding frames of the obfuscated speech signal within the obfuscated speech signal is the same as an order in time of said plurality of frames of the speech signal within the speech signal.

35. The apparatus according to claim 30, wherein each of said plurality of different frequencies is a harmonic of a pitch frequency of the speech signal.

36. The apparatus according to claim 30, wherein said apparatus comprises an interpolator configured to interpolate between estimates of a pitch frequency of the speech signal to obtain a pitch track of the speech signal, and wherein said plurality of different frequencies is based on said obtained pitch track.

37. The apparatus according to claim 36, wherein said speech signal is based on an encoded signal that includes a plurality of pitch lag values, and wherein said pitch track is based on said plurality of pitch lag values.

38. The apparatus according to claim 29, wherein energy of the source component is concentrated along a source direction relative to an axis of the transducer, and
wherein energy of the masking component is concentrated along a leakage direction, relative to said axis, that is different than the source direction.

39. The apparatus according to claim 38, wherein said multichannel masking signal is based on an estimated intensity of the source component in the leakage direction.

40. The apparatus according to claim 39, wherein said estimated intensity of the source component in the leakage direction is based on coefficient values of the first spatially directive filter.

41. The apparatus according to claim 29, wherein said apparatus comprises a direction-of-arrival estimator configured to estimate a direction of a user relative to the directionally controllable transducer, and
wherein said source direction is based on said estimated user direction.

42. The apparatus according to claim 29, wherein the masking component includes a null in the source direction.

43. A non-transitory computer-readable data storage medium having tangible features that cause a machine reading the features to:
produce a multichannel source signal that is based on a speech signal;
produce an obfuscated speech signal that is based on the speech signal;
produce a multichannel masking signal that is based on the obfuscated speech signal; and
drive a directionally controllable transducer, in response to the multichannel source signal and the multichannel masking signal, to produce a sound field comprising (A) a source component that is based on the multichannel source signal and (B) a masking component that is based on the multichannel masking signal.
